(19) United States
(12) Patent Application Publication
(10) Pub. No.: US 2020/0314796 A1
(43) Pub. Date: Oct. 1, 2020

(54) METHOD AND APPARATUS FOR SIDELINK SIGNALLING IN WIRELESS COMMUNICATION SYSTEM

(71) Applicant: LG Electronics Inc., Seoul (KR)

(72) Inventors: Youngdae Lee, Seoul (KR); Giwon Park, Seoul (KR); Jongyoul Lee, Seoul (KR)

(21) Appl. No.: 16/832,656

(22) Filed: Mar. 27, 2020

(30) Foreign Application Priority Data
Mar. 28, 2019 (KR) 1020190036314
Mar. 28, 2019 (KR) 1020190036351
Mar. 28, 2019 (KR) 1020190036363

(51) Int. Cl. H04W 68/00; H04W 80/02; H04W 72/04; H04W 80/08

(52) U.S. Cl. CPC H04W 68/005; H04W 80/02; H04W 92/18; H04W 80/08; H04W 72/0453

(57) ABSTRACT

The present disclosure relates to sidelink signalling in wireless communications. According to an embodiment of the present disclosure, a method performed by a first wireless device in a wireless communication system comprises: generating, by an entity of a first radio access technology (RAT), a first signalling message duplicated from a second signalling message; and transmitting the first signalling message on a carrier of the first RAT and the second signalling message on a carrier of a second RAT, wherein the second signalling message is transmitted with information informing that a duplication is performed by the entity of the first RAT, and wherein the entity is an upper entity with respect to a media access control (MAC) entity.

### CROSS-REFERENCE TO RELATED APPLICATIONS

Pursuant to 35 U.S.C. § 119 (e), this application claims the benefit of Korean Patent Applications No. 10-2019-0036314, filed on Mar. 28, 2019, No. 10-2019-0036363, filed on Mar. 28, 2019 and No. 10-2019-0036351, filed on Mar. 28, 2019, the contents of which are all hereby incorporated by reference herein in their entirety.

### BACKGROUND OF THE DISCLOSURE

### Field of the Disclosure

The present disclosure relates to sidelink signalling in wireless communications.

### Related Art

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

User equipments (UEs) in a wireless communication system can communication with each other via a network infrastructure (e.g., RAN node), or via a direct communication link between the UEs. This direct communication link may be referred to as sidelink, and the UEs can perform direct communication with each other. UEs may exchange sidelink signallings with each other for a sidelink communication. Transmissions for exchange of the sidelink signallings should be reliable enough to provide robustness to sidelink connectivity between those UEs.

### SUMMARY OF THE DISCLOSURE

### Technical Problem

An aspect of the present disclosure is to provide method and apparatus for sidelink signalling in a wireless communication system.

Another aspect of the present disclosure is to provide method and apparatus for exchanging PC5-RRC messages in a wireless communication system.

Another aspect of the present disclosure is to provide method and apparatus for duplicating signalling messages in a wireless communication system.

Another aspect of the present disclosure is to provide method and apparatus for transmitting duplicated signalling messages in a wireless communication system.

### Technical Solution

According to an embodiment of the present disclosure, a method performed by a first wireless device in a wireless communication system comprises: generating, by an entity of a first radio access technology (RAT), a first signalling message duplicated from a second signalling message; and transmitting the first signalling message on a carrier of the first RAT and the second signalling message on a carrier of a second RAT, wherein the second signalling message is transmitted with information informing that a duplication is performed by the entity of the first RAT, and wherein the entity is an upper entity with respect to a media access control (MAC) entity.

According to an embodiment of the present disclosure, a wireless device in a wireless communication system comprises: a transceiver; a memory; and at least one processor operatively coupled to the transceiver and the memory, and configured to: generate, by an entity of a first radio access technology (RAT), a first signalling message duplicated from a second signalling message, and control the transceiver to transmit the first signalling message on a carrier of the first RAT and the second signalling message on a carrier of a second RAT, wherein the second signalling message is transmitted with information informing that a duplication is performed by the entity of the first RAT, and wherein the entity is an upper entity with respect to a media access control (MAC) entity.

According to an embodiment of the present disclosure, a processor for a wireless device in a wireless communication system is configured to control the wireless device to perform operations comprising: generating, by an entity of a first radio access technology (RAT), a first signalling message duplicated from a second signalling message; and transmitting the first signalling message on a carrier of the first RAT and the second signalling message on a carrier of a second RAT, wherein the second signalling message is transmitted with information informing that a duplication is performed by the entity of the first RAT, and wherein the entity is an upper entity with respect to a media access control (MAC) entity.

### Advantageous Effect

The present disclosure can have various advantageous effects.

For example, a wireless device may duplicate and transmit a signalling message on different RATs and transmit information indicating that the duplication is performed by an entity of a specific RAT (e.g., NR), so that the wireless device can support a reliable transmission of the signalling message (e.g., control plane message).

For example, a UE can support a reliable transmission of a control plane message in sidelink by using multiple RATs, in particular when V2X sidelink communication is configured in both LTE and NR for a unicast service.

Various embodiments of the present disclosure are beneficial in that the system can provide reliable delivery of signalling to UEs in sidelink transmissions.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows examples of 5G usage scenarios to which the technical features of the present disclosure can be applied.

FIG. 2 shows an example of a wireless communication system to which the technical features of the present disclosure can be applied.

FIG. 3 shows an example of a wireless communication system to which the technical features of the present disclosure can be applied.

FIG. 4 shows another example of a wireless communication system to which the technical features of the present disclosure can be applied.

FIG. 5 shows a block diagram of a user plane protocol stack to which the technical features of the present disclosure can be applied.

FIG. 6 shows a block diagram of a control plane protocol stack to which the technical features of the present disclosure can be applied.

FIG. 7 illustrates a frame structure in a 3GPP based wireless communication system.

FIG. 8 illustrates a data flow example in the 3GPP NR system.

FIG. 9 shows an example of communication links to which technical features of the present disclosure can be applied.

FIG. 10 shows an example of sidelink connectivity types to which technical features of the present disclosure can be applied.

FIG. 11 shows an example of sidelink channel mapping to which technical features of the present disclosure can be applied.

FIG. 12 shows an example of a control plane protocol stack for sidelink communication to which technical features of the present disclosure can be applied.

FIG. 13 shows an example of a direct link setup procedure to which technical features of the present disclosure can be applied.

FIG. 14 shows an example of a direct security mode control procedure to which technical features of the present disclosure can be applied.

FIG. 15 shows an example of a direct link release procedure to which technical features of the present disclosure can be applied.

FIG. 16 shows an example of a method for transmitting duplicated signalling messages according to an embodiment of the present disclosure.

FIG. 17 shows an example of signalling message exchange between UEs according to an embodiment of the present disclosure.

FIG. 18 shows a UE to implement an embodiment of the present disclosure. The present disclosure described above for UE side may be applied to this embodiment.

FIG. 19 shows another example of a wireless communication system to which the technical features of the present disclosure can be applied.

FIG. 20 shows an example of an AI device to which the technical features of the present disclosure can be applied.

FIG. 21 shows an example of an AI system to which the technical features of the present disclosure can be applied.

### DESCRIPTION OF EXEMPLARY EMBODIMENTS

The technical features described below may be used by a communication standard by the 3rd generation partnership project (3GPP) standardization organization, a communication standard by the institute of electrical and electronics engineers (IEEE), etc. For example, the communication standards by the 3GPP standardization organization include long-term evolution (LTE) and/or evolution of LTE systems. The evolution of LTE systems includes LTE-advanced (LTE-A), LTE-A Pro, and/or 5G new radio (NR). The communication standard by the IEEE standardization organization includes a wireless local area network (WLAN) system such as IEEE 802.11a/b/g/n/ac/ax. The above system uses various multiple access technologies such as orthogonal frequency division multiple access (OFDMA) and/or single carrier frequency division multiple access (SC-FDMA) for downlink (DL) and/or uplink (UL). For example, only OFDMA may be used for DL and only SC-FDMA may be used for UL. Alternatively, OFDMA and SC-FDMA may be used for DL and/or UL.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDDCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Throughout the disclosure, the terms ‘radio access network (RAN) node’, ‘base station’, ‘eNB’, ‘gNB’ and ‘cell’ may be used interchangeably. Further, a UE may be a kind of a wireless device, and throughout the disclosure, the terms ‘UE’ and ‘wireless device’ may be used interchangeably.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings.

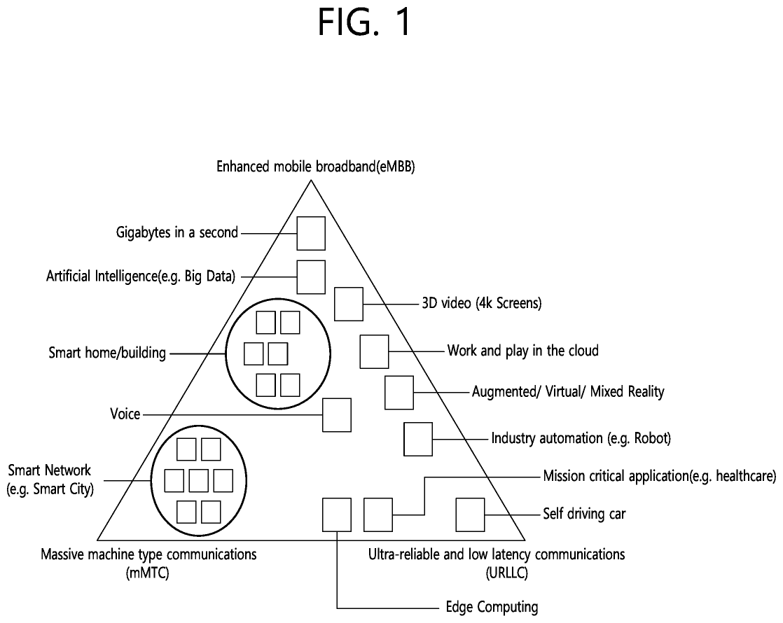

FIG. 1 shows examples of 5G usage scenarios to which the technical features of the present disclosure can be applied.

The 5G usage scenarios shown in FIG. 1 are only exemplary, and the technical features of the present disclosure can be applied to other 5G usage scenarios which are not shown in FIG. 1.

Referring to FIG. 1, the three main requirements areas of 5G include (1) enhanced mobile broadband (eMBB) domain, (2) massive machine type communication (mMTC) area, and (3) ultra-reliable and low latency communications (URLLC) area. Some use cases may require multiple areas for optimization and, other use cases may only focus on only one key performance indicator (KPI). 5G is to support these various use cases in a flexible and reliable way.

eMBB focuses on across-the-board enhancements to the data rate, latency, user density, capacity and coverage of mobile broadband access. The eMBB aims ˜10 Gbps of throughput. eMBB far surpasses basic mobile Internet access and covers rich interactive work and media and entertainment applications in cloud and/or augmented reality. Data is one of the key drivers of 5G and may not be able to see dedicated voice services for the first time in the 5G era. In 5G, the voice is expected to be processed as an application simply using the data connection provided by the communication system. The main reason for the increased volume of traffic is an increase in the size of the content and an increase in the number of applications requiring high data rates. Streaming services (audio and video), interactive video and mobile Internet connectivity will become more common as more devices connect to the Internet. Many of these applications require always-on connectivity to push real-time information and notifications to the user. Cloud storage and applications are growing rapidly in mobile communication platforms, which can be applied to both work and entertainment. Cloud storage is a special use case that drives growth of uplink data rate. 5G is also used for remote tasks on the cloud and requires much lower end-to-end delay to maintain a good user experience when the tactile interface is used. In entertainment, for example, cloud games and video streaming are another key factor that increases the demand for mobile broadband capabilities. Entertainment is essential in smartphones and tablets anywhere, including high mobility environments such as trains, cars and airplanes. Another use case is augmented reality and information retrieval for entertainment. Here, augmented reality requires very low latency and instantaneous data amount.

mMTC is designed to enable communication between devices that are low-cost, massive in number and battery-driven, intended to support applications such as smart metering, logistics, and field and body sensors. mMTC aims ˜10 years on battery and/or ˜1 million devices/km2. mMTC allows seamless integration of embedded sensors in all areas and is one of the most widely used 5G applications. Potentially by 2020, internet-of-things (IoT) devices are expected to reach 20.4 billion. Industrial IoT is one of the areas where 5G plays a key role in enabling smart cities, asset tracking, smart utilities, agriculture and security infrastructures.

URLLC will make it possible for devices and machines to communicate with ultra-reliability, very low latency and high availability, making it ideal for vehicular communication, industrial control, factory automation, remote surgery, smart grids and public safety applications. URLLC aims ˜1 ms of latency. URLLC includes new services that will change the industry through links with ultra-reliability/low latency, such as remote control of key infrastructure and self-driving vehicles. The level of reliability and latency is essential for smart grid control, industrial automation, robotics, drones control and coordination.

Next, a plurality of use cases included in the triangle of FIG. 1 will be described in more detail.

5G can complement fiber-to-the-home (FTTH) and cable-based broadband (or DOCSIS) as a means of delivering streams rated from hundreds of megabits per second to gigabits per second. This high speed can be required to deliver TVs with resolutions of 4K or more (6K, 8K and above) as well as virtual reality (VR) and augmented reality (AR). VR and AR applications include mostly immersive sporting events. Certain applications may require special network settings. For example, in the case of a VR game, a game company may need to integrate a core server with an edge network server of a network operator to minimize delay.

Automotive is expected to become an important new driver for 5G, with many use cases for mobile communications to vehicles. For example, entertainment for passengers demands high capacity and high mobile broadband at the same time. This is because future users will continue to expect high-quality connections regardless of their location and speed. Another use case in the automotive sector is an augmented reality dashboard. The driver can identify an object in the dark on top of what is being viewed through the front window through the augmented reality dashboard. The augmented reality dashboard displays information that will inform the driver about the object's distance and movement. In the future, the wireless module enables communication between vehicles, information exchange between the vehicle and the supporting infrastructure, and information exchange between the vehicle and other connected devices (e.g. devices accompanied by a pedestrian). The safety system allows the driver to guide the alternative course of action so that he can drive more safely, thereby reducing the risk of accidents. The next step will be a remotely controlled vehicle or self-driving vehicle. This requires a very reliable and very fast communication between different self-driving vehicles and between vehicles and infrastructure. In the future, a self-driving vehicle will perform all driving activities, and the driver will focus only on traffic that the vehicle itself cannot identify. The technical requirements of self-driving vehicles require ultra-low latency and high-speed reliability to increase traffic safety to a level not achievable by humans.

Smart cities and smart homes, which are referred to as smart societies, will be embedded in high density wireless sensor networks. The distributed network of intelligent sensors will identify conditions for cost and energy-efficient maintenance of a city or house. A similar setting can be performed for each home. Temperature sensors, windows and heating controllers, burglar alarms and appliances are all wirelessly connected. Many of these sensors typically require low data rate, low power and low cost. However, for example, real-time high-definition (HD) video may be required for certain types of devices for monitoring.

The consumption and distribution of energy, including heat or gas, is highly dispersed, requiring automated control of distributed sensor networks. The smart grid interconnects these sensors using digital information and communication technologies to collect and act on information. This information can include supplier and consumer behavior, allowing the smart grid to improve the distribution of fuel, such as electricity, in terms of efficiency, reliability, economy, production sustainability, and automated methods. The smart grid can be viewed as another sensor network with low latency.

The health sector has many applications that can benefit from mobile communications. Communication systems can support telemedicine to provide clinical care in remote locations. This can help to reduce barriers to distance and improve access to health services that are not continuously available in distant rural areas. It is also used to save lives in critical care and emergency situations. Mobile communication based wireless sensor networks can provide remote monitoring and sensors for parameters such as heart rate and blood pressure.

Wireless and mobile communications are becoming increasingly important in industrial applications. Wiring costs are high for installation and maintenance. Thus, the possibility of replacing a cable with a wireless link that can be reconfigured is an attractive opportunity in many industries. However, achieving this requires that wireless connections operate with similar delay, reliability, and capacity as cables and that their management is simplified. Low latency and very low error probabilities are new requirements that need to be connected to 5G.

Logistics and freight tracking are important use cases of mobile communications that enable tracking of inventory and packages anywhere using location based information systems. Use cases of logistics and freight tracking typically require low data rates, but require a large range and reliable location information.

NR supports multiple numerology (or, subcarrier spacing (SCS)) to support various 5G services. For example, when the SCS is 15 kHz, wide area in traditional cellular bands may be supported. When the SCS is 30 kHz/60 kHz, dense-urban, lower latency and wider carrier bandwidth may be supported. When the SCS is 60 kHz or higher, a bandwidth greater than 24.25 GHz may be supported to overcome phase noise.

The NR frequency band may be defined as two types of frequency range, i.e., FR1 and FR2. The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter wave (mmW).

TABLE 1

| Frequency Range | Corresponding frequency | |
|---|---|---|
| designation | range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding frequency | |
|---|---|---|
| designation | range | Subcarrier Spacing |
| FR1 | 410 MHz-7125 MHz | 15, 30, 60 kHz |
| FR2 | 24250 MHz-52600 MHz | 60, 120, 240 kHz |

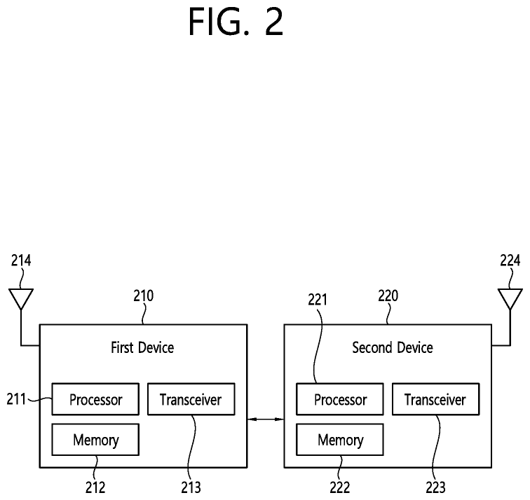

FIG. 2 shows an example of a wireless communication system to which the technical features of the present disclosure can be applied.

Referring to FIG. 2, the wireless communication system may include a first device 210 and a second device 220.

The first device 210 includes a base station, a network node, a transmitting UE, a receiving UE, a wireless device, a wireless communication device, a vehicle, a vehicle equipped with an autonomous driving function, a connected car, a drone, an unmanned aerial vehicle (UAV), an artificial intelligence (AI) module, a robot, an AR device, a VR device, a mixed reality (MR) device, a hologram device, a public safety device, an MTC device, an IoT device, a medical device, a fin-tech device (or, a financial device), a security device, a climate/environmental device, a device related to 5G services, or a device related to the fourth industrial revolution.

The second device 220 includes a base station, a network node, a transmitting UE, a receiving UE, a wireless device, a wireless communication device, a vehicle, a vehicle equipped with an autonomous driving function, a connected car, a drone, a UAV, an AI module, a robot, an AR device, a VR device, an MR device, a hologram device, a public safety device, an MTC device, an IoT device, a medical device, a fin-tech device (or, a financial device), a security device, a climate/environmental device, a device related to 5G services, or a device related to the fourth industrial revolution.

For example, the UE may include a mobile phone, a smart phone, a laptop computer, a digital broadcasting terminal, a personal digital assistant (PDA), a portable multimedia player (PMP), a navigation device, a slate personal computer (PC), a tablet PC, an ultrabook, a wearable device (e.g. a smartwatch, a smart glass, a head mounted display (HMD)). For example, the HMD may be a display device worn on the head. For example, the HMD may be used to implement AR, VR and/or MR.

For example, the drone may be a flying object that is flying by a radio control signal without a person boarding it. For example, the VR device may include a device that implements an object or background in the virtual world. For example, the AR device may include a device that implements connection of an object and/or a background of a virtual world to an object and/or a background of the real world. For example, the MR device may include a device that implements fusion of an object and/or a background of a virtual world to an object and/or a background of the real world. For example, the hologram device may include a device that implements a 360-degree stereoscopic image by recording and playing stereoscopic information by utilizing a phenomenon of interference of light generated by the two laser lights meeting with each other, called holography. For example, the public safety device may include a video relay device or a video device that can be worn by the user's body. For example, the MTC device and the IoT device may be a device that do not require direct human intervention or manipulation. For example, the MTC device and the IoT device may include a smart meter, a vending machine, a thermometer, a smart bulb, a door lock and/or various sensors. For example, the medical device may be a device used for the purpose of diagnosing, treating, alleviating, handling, or preventing a disease. For example, the medical device may be a device used for the purpose of diagnosing, treating, alleviating, or correcting an injury or disorder. For example, the medical device may be a device used for the purpose of inspecting, replacing or modifying a structure or function. For example, the medical device may be a device used for the purpose of controlling pregnancy. For example, the medical device may include a treatment device, a surgical device, an (in vitro) diagnostic device, a hearing aid and/or a procedural device, etc. For example, a security device may be a device installed to prevent the risk that may occur and to maintain safety. For example, the security device may include a camera, a closed-circuit TV (CCTV), a recorder, or a black box. For example, the fin-tech device may be a device capable of providing financial services such as mobile payment. For example, the fin-tech device may include a payment device or a point of sales (POS). For example, the climate/environmental device may include a device for monitoring or predicting the climate/environment.

The first device 210 may include at least one or more processors, such as a processor 211, at least one memory, such as a memory 212, and at least one transceiver, such as a transceiver 213. The processor 211 may perform the functions, procedures, and/or methods of the first device described throughout the disclosure. The processor 211 may perform one or more protocols. For example, the processor 211 may perform one or more layers of the air interface protocol. The memory 212 is connected to the processor 211 and may store various types of information and/or instructions. The transceiver 213 is connected to the processor 211 and may be controlled by the processor 211 to transmit and receive wireless signals.

The second device 220 may include at least one or more processors, such as a processor 221, at least one memory, such as a memory 222, and at least one transceiver, such as a transceiver 223. The processor 221 may perform the functions, procedures, and/or methods of the second device 220 described throughout the disclosure. The processor 221 may perform one or more protocols. For example, the processor 221 may perform one or more layers of the air interface protocol. The memory 222 is connected to the processor 221 and may store various types of information and/or instructions. The transceiver 223 is connected to the processor 221 and may be controlled by the processor 221 to transmit and receive wireless signals.

The memory 212, 222 may be connected internally or externally to the processor 211, 212, or may be connected to other processors via a variety of technologies such as wired or wireless connections.

The first device 210 and/or the second device 220 may have more than one antenna. For example, antenna 214 and/or antenna 224 may be configured to transmit and receive wireless signals.

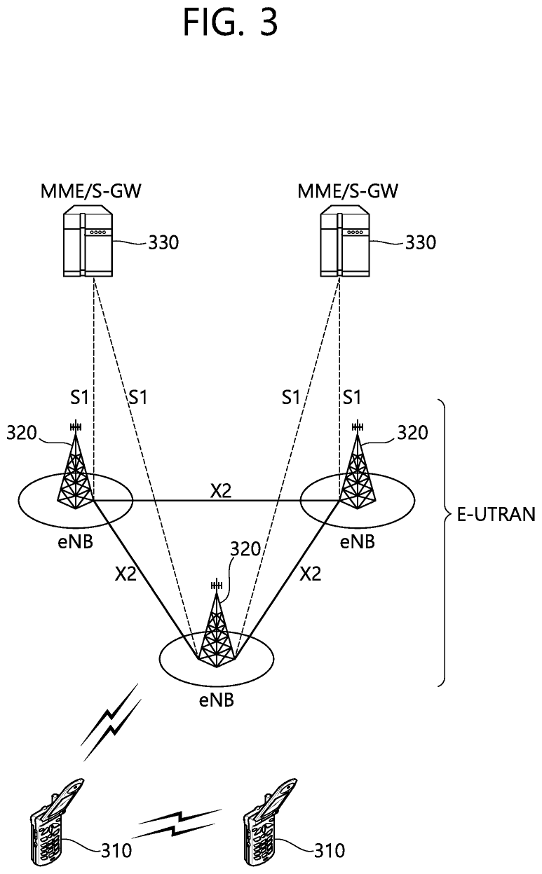

FIG. 3 shows an example of a wireless communication system to which the technical features of the present disclosure can be applied.

Specifically, FIG. 3 shows a system architecture based on an evolved-UMTS terrestrial radio access network (E-UTRAN). The aforementioned LTE is a part of an evolved-UTMS (e-UMTS) using the E-UTRAN.

Referring to FIG. 3, the wireless communication system includes one or more user equipment (UE) 310, an E-UTRAN and an evolved packet core (EPC). The UE 310 refers to a communication equipment carried by a user. The UE 310 may be fixed or mobile. The UE 310 may be referred to as another terminology, such as a mobile station (MS), a user terminal (UT), a subscriber station (SS), a wireless device, etc.

The E-UTRAN consists of one or more evolved NodeB (eNB) 320. The eNB 320 provides the E-UTRA user plane and control plane protocol terminations towards the UE 10. The eNB 320 is generally a fixed station that communicates with the UE 310. The eNB 320 hosts the functions, such as inter-cell radio resource management (RRM), radio bearer (RB) control, connection mobility control, radio admission control, measurement configuration/provision, dynamic resource allocation (scheduler), etc. The eNB 320 may be referred to as another terminology, such as a base station (BS), a base transceiver system (BTS), an access point (AP), etc.

A downlink (DL) denotes communication from the eNB 320 to the UE 310. An uplink (UL) denotes communication from the UE 310 to the eNB 320. A sidelink (SL) denotes communication between the UEs 310. In the DL, a transmitter may be a part of the eNB 320, and a receiver may be a part of the UE 310. In the UL, the transmitter may be a part of the UE 310, and the receiver may be a part of the eNB 320. In the SL, the transmitter and receiver may be a part of the UE 310.

The EPC includes a mobility management entity (MME), a serving gateway (S-GW) and a packet data network (PDN) gateway (P-GW). The MME hosts the functions, such as non-access stratum (NAS) security, idle state mobility handling, evolved packet system (EPS) bearer control, etc. The S-GW hosts the functions, such as mobility anchoring, etc. The S-GW is a gateway having an E-UTRAN as an endpoint. For convenience, MME/S-GW 330 will be referred to herein simply as a “gateway,” but it is understood that this entity includes both the MME and S-GW. The P-GW hosts the functions, such as UE Internet protocol (IP) address allocation, packet filtering, etc. The P-GW is a gateway having a PDN as an endpoint. The P-GW is connected to an external network.

The UE 310 is connected to the eNB 320 by means of the Uu interface. The UEs 310 are interconnected with each other by means of the PC5 interface. The eNBs 320 are interconnected with each other by means of the X2 interface. The eNBs 320 are also connected by means of the S1 interface to the EPC, more specifically to the MME by means of the S1-MME interface and to the S-GW by means of the S1-U interface. The S1 interface supports a many-to-many relation between MMEs/S-GWs and eNBs.

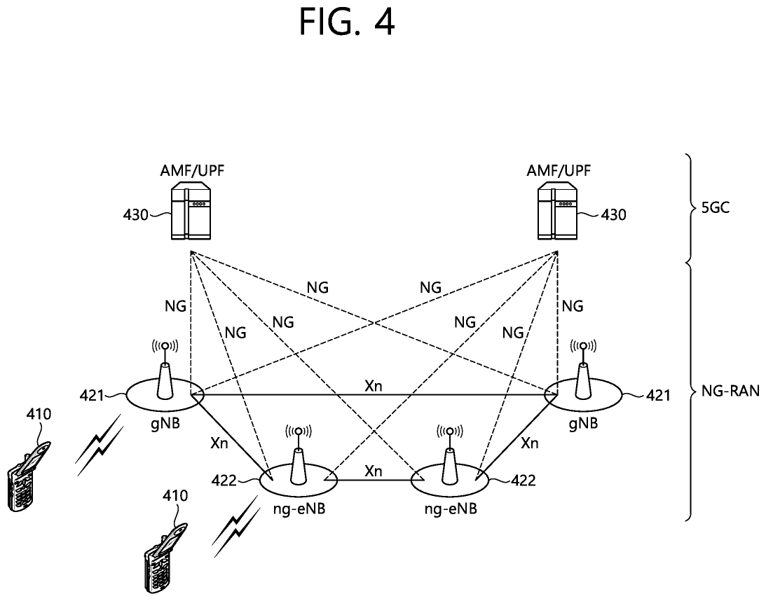

FIG. 4 shows another example of a wireless communication system to which the technical features of the present disclosure can be applied.

Specifically, FIG. 4 shows a system architecture based on a 5G NR. The entity used in the 5G NR (hereinafter, simply referred to as “NR”) may absorb some or all of the functions of the entities introduced in FIG. 3 (e.g. eNB, MME, S-GW). The entity used in the NR may be identified by the name “NG” for distinction from the LTE/LTE-A.

Referring to FIG. 4, the wireless communication system includes one or more UE 410, a next-generation RAN (NG-RAN) and a 5th generation core network (5GC). The NG-RAN consists of at least one NG-RAN node. The NG-RAN node is an entity corresponding to the eNB 320 shown in FIG. 3. The NG-RAN node consists of at least one gNB 421 and/or at least one ng-eNB 422. The gNB 421 provides NR user plane and control plane protocol terminations towards the UE 410. The ng-eNB 422 provides E-UTRA user plane and control plane protocol terminations towards the UE 410.

The 5GC includes an access and mobility management function (AMF), a user plane function (UPF) and a session management function (SMF). The AMF hosts the functions, such as NAS security, idle state mobility handling, etc. The AMF is an entity including the functions of the conventional MME. The UPF hosts the functions, such as mobility anchoring, protocol data unit (PDU) handling. The UPF an entity including the functions of the conventional S-GW. The SMF hosts the functions, such as UE IP address allocation, PDU session control.

The gNBs 421 and ng-eNBs 422 are interconnected with each other by means of the Xn interface. The gNBs 421 and ng-eNBs 422 are also connected by means of the NG interfaces to the 5GC, more specifically to the AMF by means of the NG-C interface and to the UPF by means of the NG-U interface.

A protocol structure between network entities described above is described. On the system of FIG. 3 and/or FIG. 4, layers of a radio interface protocol between the UE and the network (e.g. NG-RAN and/or E-UTRAN) may be classified into a first layer (L1), a second layer (L2), and a third layer (L3) based on the lower three layers of the open system interconnection (OSI) model that is well-known in the communication system.

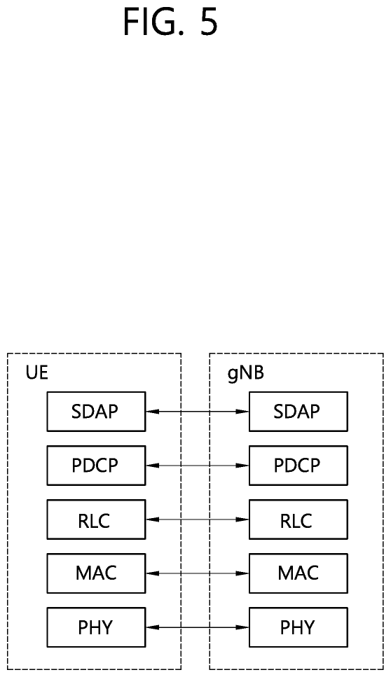

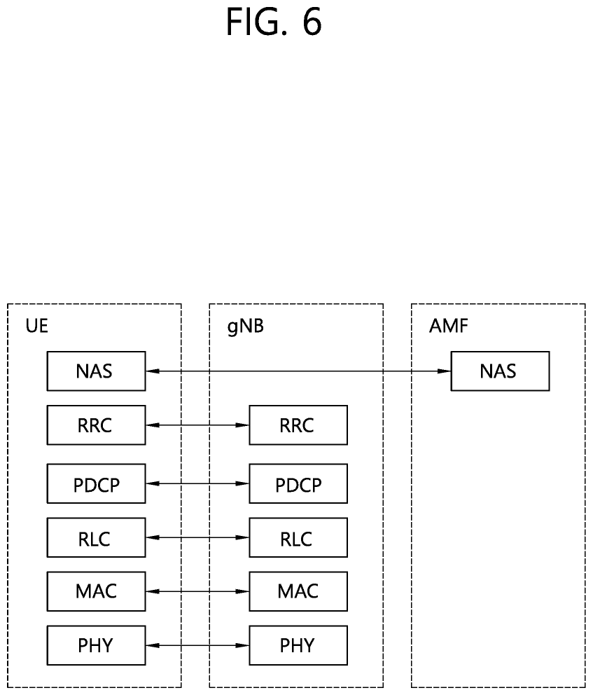

FIG. 5 shows a block diagram of a user plane protocol stack to which the technical features of the present disclosure can be applied. FIG. 6 shows a block diagram of a control plane protocol stack to which the technical features of the present disclosure can be applied.

The user/control plane protocol stacks shown in FIG. 5 and FIG. 6 are used in NR. However, user/control plane protocol stacks shown in FIG. 5 and FIG. 6 may be used in LTE/LTE-A without loss of generality, by replacing gNB/AMF with eNB/MME.

Referring to FIG. 5 and FIG. 6, a physical (PHY) layer belonging to L1. The PHY layer offers information transfer services to media access control (MAC) sublayer and higher layers. The PHY layer offers to the MAC sublayer transport channels. Data between the MAC sublayer and the PHY layer is transferred via the transport channels. Between different PHY layers, i.e., between a PHY layer of a transmission side and a PHY layer of a reception side, data is transferred via the physical channels.

The MAC sublayer belongs to L2. The main services and functions of the MAC sublayer include mapping between logical channels and transport channels, multiplexing/de-multiplexing of MAC service data units (SDUs) belonging to one or different logical channels into/from transport blocks (TB) delivered to/from the physical layer on transport channels, scheduling information reporting, error correction through hybrid automatic repeat request (HARQ), priority handling between UEs by means of dynamic scheduling, priority handling between logical channels of one UE by means of logical channel prioritization (LCP), etc. The MAC sublayer offers to the radio link control (RLC) sublayer logical channels.

The RLC sublayer belong to L2. The RLC sublayer supports three transmission modes, i.e. transparent mode (TM), unacknowledged mode (UM), and acknowledged mode (AM), in order to guarantee various quality of services (QoS) required by radio bearers. The main services and functions of the RLC sublayer depend on the transmission mode. For example, the RLC sublayer provides transfer of upper layer PDUs for all three modes, but provides error correction through ARQ for AM only. In LTE/LTE-A, the RLC sublayer provides concatenation, segmentation and reassembly of RLC SDUs (only for UM and AM data transfer) and re-segmentation of RLC data PDUs (only for AM data transfer). In NR, the RLC sublayer provides segmentation (only for AM and UM) and re-segmentation (only for AM) of RLC SDUs and reassembly of SDU (only for AM and UM). That is, the NR does not support concatenation of RLC SDUs. The RLC sublayer offers to the packet data convergence protocol (PDCP) sublayer RLC channels.

The PDCP sublayer belong to L2. The main services and functions of the PDCP sublayer for the user plane include header compression and decompression, transfer of user data, duplicate detection, PDCP PDU routing, retransmission of PDCP SDUs, ciphering and deciphering, etc. The main services and functions of the PDCP sublayer for the control plane include ciphering and integrity protection, transfer of control plane data, etc.

The service data adaptation protocol (SDAP) sublayer belong to L2. The SDAP sublayer is only defined in the user plane. The SDAP sublayer is only defined for NR. The main services and functions of SDAP include, mapping between a QoS flow and a data radio bearer (DRB), and marking QoS flow ID (QFI) in both DL and UL packets. The SDAP sublayer offers to 5GC QoS flows.

A radio resource control (RRC) layer belongs to L3. The RRC layer is only defined in the control plane. The RRC layer controls radio resources between the UE and the network. To this end, the RRC layer exchanges RRC messages between the UE and the BS. The main services and functions of the RRC layer include broadcast of system information related to AS and NAS, paging, establishment, maintenance and release of an RRC connection between the UE and the network, security functions including key management, establishment, configuration, maintenance and release of radio bearers, mobility functions, QoS management functions, UE measurement reporting and control of the reporting, NAS message transfer to/from NAS from/to UE.

In other words, the RRC layer controls logical channels, transport channels, and physical channels in relation to the configuration, reconfiguration, and release of radio bearers. A radio bearer refers to a logical path provided by L1 (PHY layer) and L2 (MAC/RLC/PDCP/SDAP sublayer) for data transmission between a UE and a network. Setting the radio bearer means defining the characteristics of the radio protocol layer and the channel for providing a specific service, and setting each specific parameter and operation method. Radio bearer may be divided into signalling RB (SRB) and data RB (DRB). The SRB is used as a path for transmitting RRC messages in the control plane, and the DRB is used as a path for transmitting user data in the user plane.

An RRC state indicates whether an RRC layer of the UE is logically connected to an RRC layer of the E-UTRAN. In LTE/LTE-A, when the RRC connection is established between the RRC layer of the UE and the RRC layer of the E-UTRAN, the UE is in the RRC connected state (RRC_CONNECTED). Otherwise, the UE is in the RRC idle state (RRC_IDLE). In NR, the RRC inactive state (RRC_INACTIVE) is additionally introduced. RRC_INACTIVE may be used for various purposes. For example, the massive machine type communications (MMTC) UEs can be efficiently managed in RRC_INACTIVE. When a specific condition is satisfied, transition is made from one of the above three states to the other.

A predetermined operation may be performed according to the RRC state. In RRC_IDLE, public land mobile network (PLMN) selection, broadcast of system information (SI), cell re-selection mobility, core network (CN) paging and discontinuous reception (DRX) configured by NAS may be performed. The UE shall have been allocated an identifier (ID) which uniquely identifies the UE in a tracking area. No RRC context stored in the BS.

In RRC_CONNECTED, the UE has an RRC connection with the network (i.e. E-UTRAN/NG-RAN). Network-CN connection (both C/U-planes) is also established for UE. The UE AS context is stored in the network and the UE. The RAN knows the cell which the UE belongs to. The network can transmit and/or receive data to/from UE. Network controlled mobility including measurement is also performed.

Most of operations performed in RRC_IDLE may be performed in RRC_INACTIVE. But, instead of CN paging in RRC_IDLE, RAN paging is performed in RRC_INACTIVE. In other words, in RRC_IDLE, paging for mobile terminated (MT) data is initiated by core network and paging area is managed by core network. In RRC_INACTIVE, paging is initiated by NG-RAN, and RAN-based notification area (RNA) is managed by NG-RAN. Further, instead of DRX for CN paging configured by NAS in RRC_IDLE, DRX for RAN paging is configured by NG-RAN in RRC_INACTIVE. Meanwhile, in RRC_INACTIVE, 5GC-NG-RAN connection (both C/U-planes) is established for UE, and the UE AS context is stored in NG-RAN and the UE. NG-RAN knows the RNA which the UE belongs to.

NAS layer is located at the top of the RRC layer. The NAS control protocol performs the functions, such as authentication, mobility management, security control.

The physical channels may be modulated according to OFDM processing and utilizes time and frequency as radio resources. The physical channels consist of a plurality of orthogonal frequency division multiplexing (OFDM) symbols in time domain and a plurality of subcarriers in frequency domain. One subframe consists of a plurality of OFDM symbols in the time domain. A resource block is a resource allocation unit, and consists of a plurality of OFDM symbols and a plurality of subcarriers. In addition, each subframe may use specific subcarriers of specific OFDM symbols (e.g. first OFDM symbol) of the corresponding subframe for a physical downlink control channel (PDCCH), i.e. L1/L2 control channel A transmission time interval (TTI) is a basic unit of time used by a scheduler for resource allocation. The TTI may be defined in units of one or a plurality of slots, or may be defined in units of mini-slots.

The transport channels are classified according to how and with what characteristics data are transferred over the radio interface. DL transport channels include a broadcast channel (BCH) used for transmitting system information, a downlink shared channel (DL-SCH) used for transmitting user traffic or control signals, and a paging channel (PCH) used for paging a UE. UL transport channels include an uplink shared channel (UL-SCH) for transmitting user traffic or control signals and a random access channel (RACH) normally used for initial access to a cell.

Different kinds of data transfer services are offered by MAC sublayer. Each logical channel type is defined by what type of information is transferred. Logical channels are classified into two groups: control channels and traffic channels.

Control channels are used for the transfer of control plane information only. The control channels include a broadcast control channel (BCCH), a paging control channel (PCCH), a common control channel (CCCH) and a dedicated control channel (DCCH). The BCCH is a DL channel for broadcasting system control information. The PCCH is DL channel that transfers paging information, system information change notifications. The CCCH is a channel for transmitting control information between UEs and network. This channel is used for UEs having no RRC connection with the network. The DCCH is a point-to-point bi-directional channel that transmits dedicated control information between a UE and the network. This channel is used by UEs having an RRC connection.

Traffic channels are used for the transfer of user plane information only. The traffic channels include a dedicated traffic channel (DTCH). The DTCH is a point-to-point channel, dedicated to one UE, for the transfer of user information. The DTCH can exist in both UL and DL.

Regarding mapping between the logical channels and transport channels, in DL, BCCH can be mapped to BCH, BCCH can be mapped to DL-SCH, PCCH can be mapped to PCH, CCCH can be mapped to DL-SCH, DCCH can be mapped to DL-SCH, and DTCH can be mapped to DL-SCH. In UL, CCCH can be mapped to UL-SCH, DCCH can be mapped to UL-SCH, and DTCH can be mapped to UL-SCH.

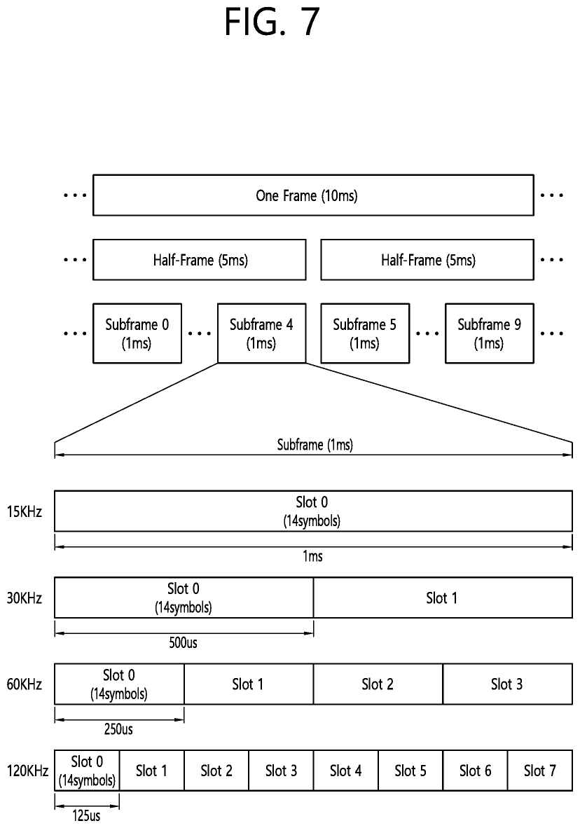

FIG. 7 illustrates a frame structure in a 3GPP based wireless communication system. The frame structure illustrated in FIG. 7 is purely exemplary and the number of subframes, the number of slots, and/or the number of symbols in a frame may be variously changed. In the 3GPP based wireless communication system, an OFDM numerology (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g. a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 7, downlink and uplink transmissions are organized into frames. Each frame has Tf=10 ms duration. Each frame is divided into two half-frames, where each of the half-frames has 5 ms duration. Each half-frame consists of 5 subframes, where the duration Tsf per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing Δf=2u*15 kHz. The following table shows the number of OFDM symbols per slot, the number of slots per frame, and the number of slots per for the normal CP, according to the subcarrier spacing Δf=2u*15 kHz.

TABLE 3

| u | Nslotsymb | Nframe, uslot | Nsubframe, uslot |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

The following table shows the number of OFDM symbols per slot, the number of slots per frame, and the number of slots per for the extended CP, according to the subcarrier spacing Δf=2u*15 kHz.

TABLE 4

| u | Nslotsymb | Nframe, uslot | Nsubframe, uslot |
|---|---|---|---|
| 2 | 12 | 40 | 4 |

A slot includes plural symbols (e.g., 14 or 12 symbols) in the time domain. For each numerology (e.g. subcarrier spacing) and carrier, a resource grid of Nsize,ugrid,x*NRBsc subcarriers and Nsubframe,usymb OFDM symbols is defined, starting at common resource block (CRB) Nstart,ugrid indicated by higher-layer signalling (e.g. radio resource control (RRC) signalling), where Nsize,ugrid,x is the number of resource blocks (RBs) in the resource grid and the subscript x is DL for downlink and UL for uplink. NRBsc is the number of subcarriers per RB. In the 3GPP based wireless communication system, NRBsc is 12 generally. There is one resource grid for a given antenna port p, subcarrier spacing configuration u, and transmission direction (DL or UL). The carrier bandwidth Nsize,ugrid for subcarrier spacing configuration u is given by the higher-layer parameter (e.g. RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index 1 representing a symbol location relative to a reference point in the time domain. In the 3GPP based wireless communication system, an RB is defined by 12 consecutive subcarriers in the frequency domain.

In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to NsizeBWP,i−1, where i is the number of the bandwidth part. The relation between the physical resource block nPRB in the bandwidth part i and the common resource block nCRB is as follows: nPRB=nCRB+NsizeBWP,i, where NsizeBWP,i is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the present disclosure, the term “cell” may refer to a geographic area to which one or more nodes provide a communication system, or refer to radio resources. A “cell” of a geographic area may be understood as coverage within which a node can provide service using a carrier and a “cell” as radio resources (e.g. time-frequency resources) is associated with bandwidth (BW) which is a frequency range configured by the carrier. The “cell” associated with the radio resources is defined by a combination of downlink resources and uplink resources, for example, a combination of a downlink (DL) component carrier (CC) and a uplink (UL) CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In carrier aggregation (CA), two or more CCs are aggregated. A UE may simultaneously receive or transmit on one or multiple CCs depending on its capabilities. CA is supported for both contiguous and non-contiguous CCs. When CA is configured the UE only has one radio resource control (RRC) connection with the network. At RRC connection establishment/re-establishment/handover, one serving cell provides the non-access stratum (NAS) mobility information, and at RRC connection re-establishment/handover, one serving cell provides the security input. This cell is referred to as the Primary Cell (PCell). The PCell is a cell, operating on the primary frequency, in which the UE either performs the initial connection establishment procedure or initiates the connection re-establishment procedure. Depending on UE capabilities, Secondary Cells (SCells) can be configured to form together with the PCell a set of serving cells. An SCell is a cell providing additional radio resources on top of Special Cell. The configured set of serving cells for a UE therefore always consists of one PCell and one or more SCells. For dual connectivity operation, the term Special Cell (SpCell) refers to the PCell of the master cell group (MCG) or the PSCell of the secondary cell group (SCG). An SpCell supports PUCCH transmission and contention-based random access, and is always activated. The MCG is a group of serving cells associated with a master node, comprising of the SpCell (PCell) and optionally one or more SCells. The SCG is the subset of serving cells associated with a secondary node, comprising of the PSCell and zero or more SCells, for a UE configured with dual connectivity (DC). For a UE in RRC_CONNECTED not configured with CA/DC there is only one serving cell comprising of the PCell. For a UE in RRC_CONNECTED configured with CA/DC the term “serving cells” is used to denote the set of cells comprising of the SpCell(s) and all SCells. In DC, two MAC entities are configured in a UE: one for the MCG and one for the SCG.

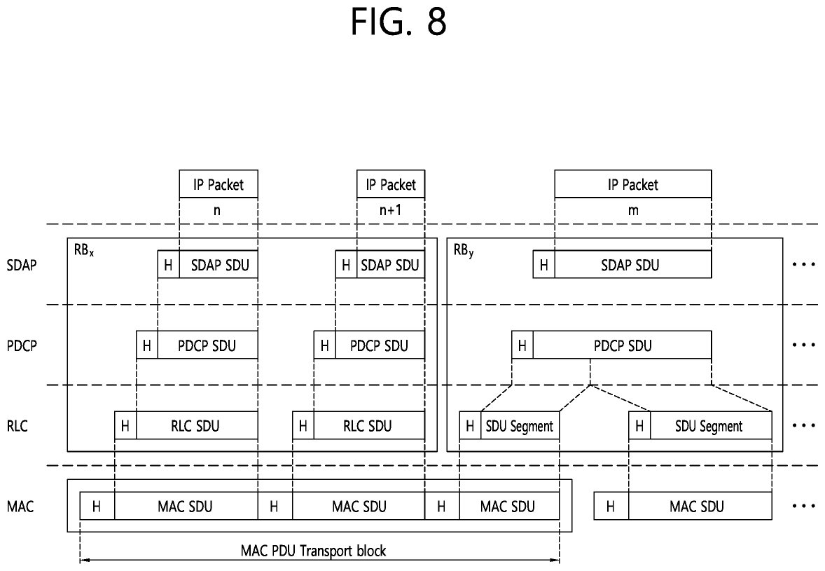

FIG. 8 illustrates a data flow example in the 3GPP NR system.

In FIG. 8, “RB” denotes a radio bearer, and “H” denotes a header. Radio bearers are categorized into two groups: data radio bearers (DRB) for user plane data and signalling radio bearers (SRB) for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels PUSCH and PRACH, respectively, and the downlink transport channels DL-SCH, BCH and PCH are mapped to PDSCH, PBCH and PDSCH, respectively. In the PHY layer, uplink control information (UCI) is mapped to PUCCH, and downlink control information (DCI) is mapped to PDCCH. A MAC PDU related to UL-SCH is transmitted by a UE via a PUSCH based on an UL grant, and a MAC PDU related to DL-SCH is transmitted by a BS via a PDSCH based on a DL assignment.

Data unit(s) (e.g. PDCP SDU, PDCP PDU, RLC SDU, RLC PDU, RLC SDU, MAC SDU, MAC CE, MAC PDU) in the present disclosure is(are) transmitted/received on a physical channel (e.g. PDSCH, PUSCH) based on resource allocation (e.g. UL grant, DL assignment). In the present disclosure, uplink resource allocation is also referred to as uplink grant, and downlink resource allocation is also referred to as downlink assignment. The resource allocation includes time domain resource allocation and frequency domain resource allocation. In the present disclosure, an uplink grant is either received by the UE dynamically on PDCCH, in a Random Access Response, or configured to the UE semi-persistently by RRC. In the present disclosure, downlink assignment is either received by the UE dynamically on the PDCCH, or configured to the UE semi-persistently by RRC signalling from the BS.

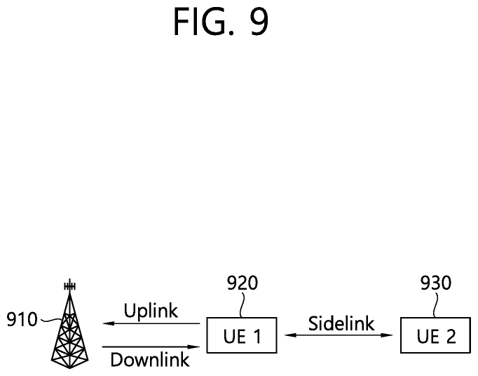

FIG. 9 shows an example of communication links to which technical features of the present disclosure can be applied.

Referring to FIG. 9, the communication links comprise uplink, downlink, and sidelink. The uplink is a communication interface from a UE (e.g., UE 920) to a base station (e.g., base station 910, such as eNB and/or gNB). The downlink is a communication interface from a base station (e.g., base station 910) to a UE (e.g., UE 920).

The sidelink is UE to UE interface for sidelink communication, sidelink discovery and/or vehicle to everything (V2X) communication. For example, the sidelink may correspond to a PC5 interface for sidelink communication, sidelink discovery and/or V2X sidelink communication.

A UE may perform a communication via network infrastructure. For example, as shown in FIG. 9, the UE1 920 may perform an uplink transmission and/or receive a downlink transmission, via the base station 910.

Also, a UE may perform a communication directly with a peer UE without using the network infrastructure. For example, as shown in FIG. 9, the UE1 920 may perform a direct communication with the UE2 930 via sidelink, without a support of the network infrastructure such as base station 910.

According to various embodiments, upper layers configure the UE to receive or transmit sidelink communication on a specific frequency, to monitor or transmit non-public safety (PS) related sidelink discovery announcements on one or more frequencies or to monitor or transmit PS related sidelink discovery announcements on a specific frequency, but only if the UE is authorized to perform these particular proximity service (ProSe) related sidelink activities.

Sidelink communication comprises one-to-many and one-to-one sidelink communication. One-to-many sidelink communication comprises relay related and non-relay related one-to-many sidelink communication. One-to-one sidelink communication comprises relay related and non-relay related one-to-one sidelink communication. In relay related one-to-one sidelink communication the communicating parties comprise one sidelink relay UE and one sidelink remote UE.

Sidelink discovery comprises public safety related (PS related) and non-PS related sidelink discovery. PS related sidelink discovery comprises relay related and non-relay related PS related sidelink discovery. Upper layers indicate to RRC whether a particular sidelink announcement is PS related or non-PS related.

According to various embodiments, upper layers indicate to radio resource control (RRC) whether a particular sidelink procedure is V2X related or not.

According to various embodiments, the UE shall perform V2X sidelink communication operation if at least one of the following conditions 1)-3) is met:

Condition 1) if the UE's serving cell is suitable (RRC_IDLE or RRC CONNECTED); and if either the selected cell on the frequency used for V2X sidelink communication operation belongs to the registered or equivalent public land mobile network (PLMN) or the UE is out of coverage on the frequency used for V2X sidelink communication operation;

Condition 2) if the UE's serving cell (for RRC_IDLE or RRC_CONNECTED) fulfils the conditions to support V2X sidelink communication in limited service state; and if either the serving cell is on the frequency used for V2X sidelink communication operation or the UE is out of coverage on the frequency used for V2X sidelink communication operation; or

Condition 3) if the UE has no serving cell (RRC_IDLE).

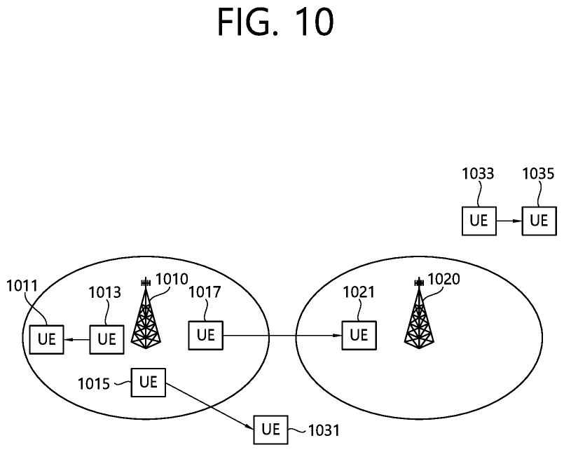

FIG. 10 shows an example of sidelink connectivity types to which technical features of the present disclosure can be applied.

Referring to FIG. 10, a sidelink connectivity between UE 1011 and UE 1013 may be “in-coverage”, where the two UEs UE 1011 and UE 1013 are under a coverage of a network (e.g., base station 1010). Also, the sidelink connectivity between the UE 1011 and the UE 1013 may be in-coverage of intra-cell type, as the UE 1011 receiving a sidelink transmission is within a same cell as the UE 1013 transmitting the sidelink transmission.

A sidelink connectivity between UE 1017 and UE 1021 may be also in-coverage, as the two UEs 1017 and 1021 are under a coverage of a network. However, unlike the case of the UE 1011 and the UE 1013, the sidelink connectivity between the UE 1017 and the UE 1021 may be in-coverage of inter-cell type, as the UE 1021 receiving a sidelink transmission is within a cell coverage of a base station 1020 while the UE 1017 transmitting the sidelink transmission is within a cell coverage of a base station 1010.

A sidelink connectivity between UE 1015 and UE 1031 may be “partial-coverage”, where one of the two UEs (e.g., UE 1015) is under a coverage of a network while the other UE (e.g., UE 1031) is outside the coverage of the network.

A sidelink connectivity between UE 1033 and UE 1035 may be “out-of-coverage”, where the two UEs UE 1033 and UE 1035 are outside a coverage of a network.

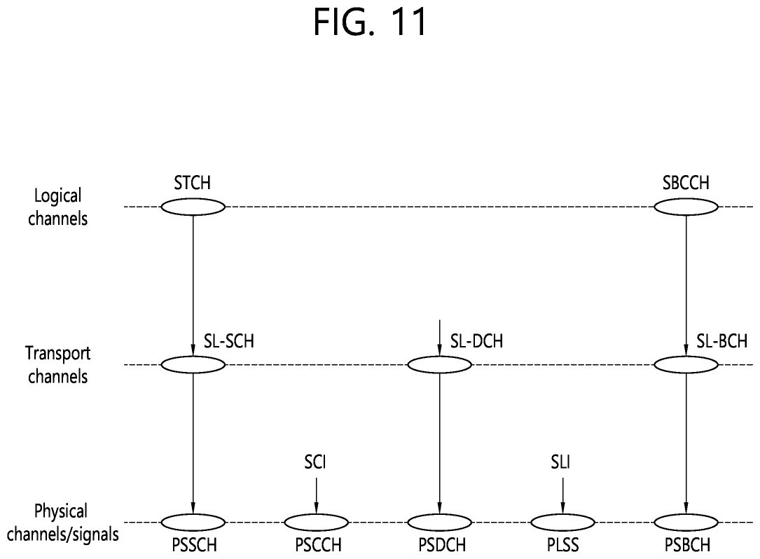

FIG. 11 shows an example of sidelink channel mapping to which technical features of the present disclosure can be applied.

Referring to FIG. 11, sidelink logical channels may comprise sidelink traffic channel (STCH) and sidelink broadcast control channel (SBCCH). Sidelink transport channels may comprise sidelink shared channel (SL-SCH), sidelink discovery channel (SL-DCH), and sidelink broadcast channel (SL-BCH). Sidelink physical channels and/or signals may comprise physical sidelink shared channel (PSSCH), physical sidelink control channel (PSCCH), physical sidelink discovery channel (PSDCH), sidelink synchronization signal (SLSS), and physical sidelink broadcast channel (PSBCH).

The STCH carries user data for sidelink communication. The STCH is mapped to the SL-SCH which, in turn, is mapped to the PSSCH.

The PSCCH carries sidelink control information (SCI). The SCI contains sidelink scheduling information such as resource block assignment, modulation and coding scheme, and/or group destination ID.

The SL-DCH is used for discovery announcements. The SL-DCH is mapped to the PSDCH.

The SLSS is a physical signal, which is used to synchronize a sidelink communication between UE and peer UE. The SLSS is associated with a specific sidelink identity (SLI).

The SBCCH is mapped to the SL-BCH which, in turn, is mapped to the PSBCH. These channels are also used for sidelink synchronization, and comprise sidelink related system information. For example, the sidelink related system information may be referred to as sidelink master information block (SL-MIB).

Although not illustrated in FIG. 11, there might be other channel(s) such as sidelink feedback channel (SL-FCH) and/or physical sidelink feedback channel (PSFCH). These channels are used to carry sidelink feedback control information (SFCI) from a device receiving a sidelink transmission.

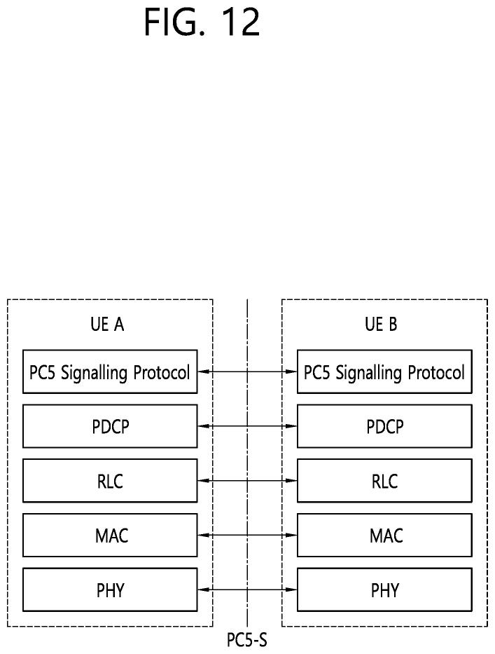

FIG. 12 shows an example of a control plane protocol stack for sidelink communication to which technical features of the present disclosure can be applied.

Referring to FIG. 12, a control plane for PC5 reference point (i.e., PC5 signalling (PC5-S) protocol stack) is depicted. The control plane protocol stack for sidelink communication may comprise PC5-S protocol, PDCP, RLC, MAC, and PHY.

The PC-5 S protocol may be used for control plane signalling over the PC5 reference point for the secure layer-2 link. The functionality of PDCP/RLC/MAC/PHY may be the same as illustrated in FIG. 5-6.

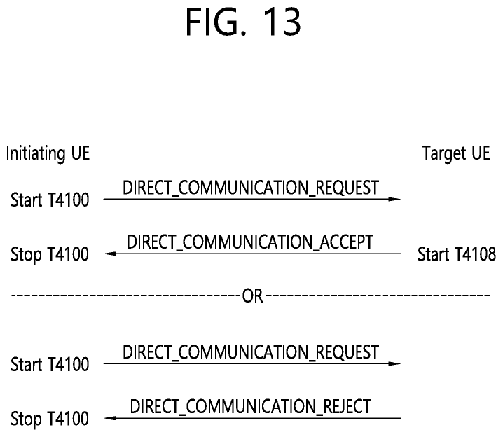

FIG. 13 shows an example of a direct link setup procedure to which technical features of the present disclosure can be applied.

Referring to FIG. 13, the direct link setup procedure may be used to establish a secure direct link between two ProSe-enabled UEs. The UE sending the request message (i.e., DIRECT_COMMUNICATION_REQUESET message) may be called the “initiating UE”, and the other UE may be called the “target UE”.

The initiating UE may generate the DIRECT_COMMUNICATION_REQUEST message. After the DIRECT_COMMUNICATION_REQUEST message is generated, the initiating UE shall pass this message to the lower layers for transmission along with the initiating UE's layer 2 ID (for unicast communication) and the target UE's Layer 2 ID (for unicast communication), and start timer T4100. The UE shall not send a new DIRECT_COMMUNICATION_REQUEST message to the same target UE while the timer T4100 is running.

Upon receiving a DIRECT_COMMUNICATION_REQUEST message, the target UE shall store the pair of Layer 2 IDs (for unicast communication) used in the transport of this message provided by the lower layers and associate them with a direct link context.

The target UE then may check the User Info IE included in the DIRECT_COMMUNICATION_REQUEST message and determine whether this request can be accepted or not. Then, the target UE may examine the IP Address Config IE to see whether there is at least one common IP address configuration option supported by both the initiating UE and the target UE. If the above check is successful, the target UE shall invoke the direct security mode control procedure to establish a security association between the target UE and the initiating UE. Only after the completion of link authentication procedure and a successful establishment of the security association, the target UE shall send a DIRECT_COMMUNICATION_ACCEPT message to the initiating UE.

If the target UE is a ProSe-UE-to-network relay UE, the target UE shall create an inactivity timer T4108 with the value provided in the Maximum Inactivity Period IE included in the DIRECT_COMMUNICATION_REQUEST message, and start the timer T4108 when it has no more messages to send over the link to be established. Once the timer T4108 is started, if any communication activity occurs before the timer T4108 expires, the UE shall stop the timer T4108 and reset it with the initial value, unless a new value is provided in a Maximum Inactivity Period IE in a DIRECT_COMMUNICATION_KEEPALIVE message.

Upon receipt of the DIRECT_COMMUNICATION_ACCEPT message, the initiating UE shall stop timer T4100. From this time onward the initiating UE shall use the established link for all one-to-one communication (including additional PC5 Signalling messages) to the target UE.

If the direct link setup request cannot be accepted, the target UE shall send a DIRECT_COMMUNICATION_REJECT message. The DIRECT_COMMUNICATION_REJECT message contains a PC5 Signalling Protocol cause value.

Upon receipt of the DIRECT_COMMUNICATION_REJECT message, the initiating UE shall stop timer T4100 and abort the direct link setup procedure. If the cause value in the DIRECT_COMMUNICATION_REJECT message is “Direct communication to target UE not allowed” or “Lack of resources for proposed link”, then the UE shall not attempt to start direct link setup with the same target UE at least for a time period T, and if the initiating UE is a remote UE requesting link setup to a ProSe UE-to-network relay UE, it shall initiate the relay reselection procedure.

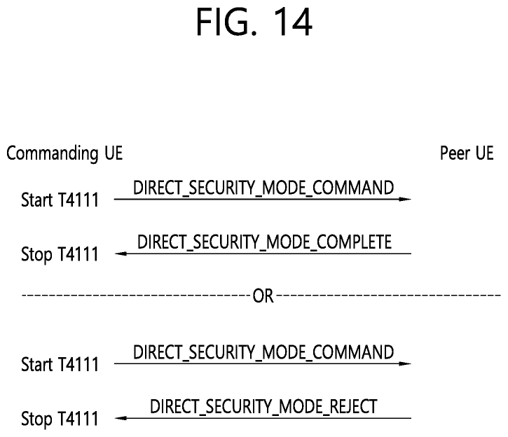

FIG. 14 shows an example of a direct security mode control procedure to which technical features of the present disclosure can be applied.

Referring to FIG. 14, the UE sending the DIRECT_SECURITY_MODE_COMMAND message may be called the “commanding UE” and the other UE may be called the “peer UE”.

The commanding UE shall send the DIRECT SECURITY MODE COMMAND message unciphered, but shall integrity protect the message with the new security context. After sending the DIRECT_SECURITY_MODE_COMMAND message, the commanding UE shall start timer T4111.

Upon receipt of the DIRECT_SECURITY_MODE_COMMAND message, the peer UE shall check whether the security mode command can be accepted or not. This may be done by performing the integrity check of the message and by checking that the received UE security capabilities have not been altered compared to the latest values that the peer UE sent to the commanding UE in the DIRECT_COMMUNICATION_REQUEST or DIRECT_REKEYING_REQUEST message.

If the DIRECT_SECURITY_MODE_COMMAND message can be accepted, the peer UE shall send a DIRECT_SECURITY_MODE_COMPLETE message ciphered and integrity protected with the new security context. The DIRECT_SECURITY_MODE_COMPLETE message shall include the 16 least significant bits of the K_{D} ID if the initiating UE included the MSB of K_{D} ID in the DIRECT_SECURITY_MODE_COMMAND message.

Upon receipt of the DIRECT_SECURITY_MODE_COMPLETE message, the commanding UE shall stop timer T4111. If an LSB of K_{D} ID IE was included in the message, the commanding UE may use this and the MSB of K_{D} ID it previously sent to form the K_{D} ID of the new K_{D}. From this time onwards the commanding UE shall protect all signalling messages and user data with the new security context.

If the DIRECT_SECURITY_MODE_COMMAND message cannot be accepted, the peer UE shall send a DIRECT_SECURITY_MODE_REJECT message. The DIRECT_SECURITY_MODE_REJECT message contains a PC5 Signalling Protocol Cause Value IE.

Upon receipt of the DIRECT_SECURITY_MODE_REJECT message, the commanding UE shall stop timer T4111. If the PC5 Signalling Protocol Cause Value IE indicates a synchronisation error and the message contained a RAND and an AUTS, then a ProSe UE-to-network relay may fetch a fresh K_{D} from the PKMF by sending a Key Request message including RAND and AUTS. Otherwise the commanding UE shall abort the ongoing procedure that triggered the initiation of the direct security mode control procedure.

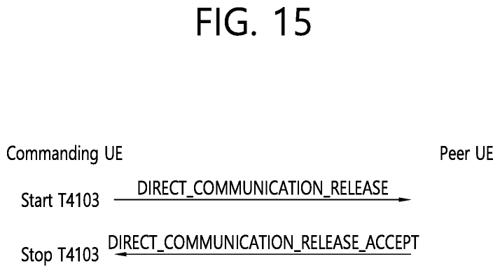

FIG. 15 shows an example of a direct link release procedure to which technical features of the present disclosure can be applied.

Referring to FIG. 15, the direct link release procedure may be used to release a secure direct link between two ProSe-enabled UEs. The link can be released from either end points. The UE sending the DIRECT_COMMUNICATION_RELEASE message may be called the “releasing UE” and the other UE may be called the “peer UE”.

The releasing UE may initiate the direct link release procedure by generating a DIRECT_COMMUNICATION_RELEASE message with a Release Reason IE. After the DIRECT_COMMUNICATION_RELEASE message is generated, the releasing UE shall pass this message to the lower layers for transmission along with the releasing UE's Layer 2 ID (for unicast communication) and the peer UE's Layer 2 ID (for unicast communication). The releasing UE shall release the direct link locally if the release reason is “Direct connection is not available any more”. Otherwise, the releasing UE shall start timer T4103.

Upon receiving a DIRECT_COMMUNICATION_RELEASE message, the peer UE shall stop timer T4101, timer T4102, timer T4103 or timer T4108 for this link, if any of those timers is running, and abort any other ongoing PC5 Signalling Protocol procedures on this link. The peer UE shall respond with a DIRECT_COMMUNICATION_RELEASE_ACCEPT message. After the message is sent, the peer UE shall remove the context of this direct link and no longer send or receive any messages via this link.

Upon receipt of the DIRECT_COMMUNICATION_RELEASE_ACCEPT message, the releasing UE shall stop timer T4103. From this time onward the releasing UE shall no longer send or receive any messages via this link.

Hereinafter, PDCP duplication is described.

For the PDCP entity configured with pdcp-Duplication, the transmitting PDCP entity (i.e., PDCP entity of a UE that intends to transmit data) shall, for SRBs, activate the PDCP duplication. For DRBs, if the activation of PDCP duplication is indicated, the transmitting PDCP entity shall activate the PDCP duplication. For DRBs, if the deactivation of PDCP duplication is indicated, the transmitting PDCP entity shall deactivate the PDCP duplication.

For the PDCP entity configured with pdcp-Duplication, the transmitting PDCP entity shall, if the successful delivery of a PDCP Data PDU is confirmed by one of the two associated AM RLC entities, indicate to the other AM RLC entity to discard the duplicated PDCP Data PDU. The transmitting PDCP entity shall, if the deactivation of PDCP duplication is indicated, indicate to the secondary RLC entity to discard all duplicated PDCP Data PDUs.

In a wireless communication system, UEs supporting sidelink communication can perform sidelink transmission and reception. In V2X communication, a UE can establish a PC5 link (i.e., one-to-one connection or session between UEs) for one or more unicast services with another UE.

PC5 signalling protocol above RRC layer in the UEs can be used for unicast link establishment and management so that the UEs may exchange PC5 signalling (i.e., upper layer signalling with respect to the RRC signalling) to successfully or unsuccessfully establish a unicast link with security activation or release the established unicast link, as shown in FIGS. 13-15 for a unicast or groupcast session.

When two UEs want to use unicast service in sidelink, those UEs may exchange PC5-RRC messages to establish unicast transmission possibly with sidelink connection. Transmissions for exchange of PC5-RRC messages should be reliable enough to provide robustness to sidelink connectivity between those UEs. Such reliability may be supported by duplicating a packet on multiple sidelink carriers. However, such duplication cannot work when only a single carrier is supported.

Therefore, various embodiments of the present disclosure proposes a method for exchanging signallings for a sidelink service. In the proposed method, if a duplication is configured for the signalling message in NR PDCP, the first UE may determine whether or not more than one carrier of the first radio access technology (RAT) is available for transmission of the signalling message.

If more than one carrier of the first RAT is not available for duplication, the first UE may determine whether or not the second RAT is available for transmission of the signalling message. The first RAT may be NR while the second RAT may be LTE.

If the first RAT is not available for duplication but the second RAT is available for duplication, the first UE may duplicate the signalling message for the first RAT and the second RAT. Then, the first UE may perform a transmission of the signalling message on a carrier of the first RAT and transmission of the duplicated signalling message on a carrier of the second RAT.

The second UE may receive an SCI and a MAC PDU carrying the signalling message. If the SCI and/or the header of the MAC PDU indicates that NR PDCP is used for the signalling message, the second UE may establish a NR PDCP entity and deliver the data unit included in the received MAC PDU to the NR PDCP entity. The SCI may refer to sidelink control information used to transmit the MAC PDU on the sidelink shared channel.

Upon receiving the signalling message from the first UE, if the signalling message indicates the duplication on different RATs, the second UE may duplicate a response message and transmit the response message to the first UE on different RATs.

Upon receiving the response message from the second UE, the first UE may begin to perform sidelink transmission on the first RAT for the service. The sidelink transmission may comprise sidelink unicast transmission.

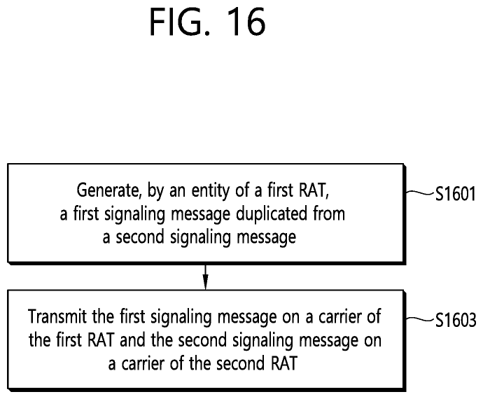

FIG. 16 shows an example of a method for transmitting duplicated signalling messages according to an embodiment of the present disclosure. Steps illustrated in FIG. 16 may be performed by a first wireless device and/or a first UE.

Referring to FIG. 16, in step S1601, the first wireless device may generate, by an entity of a first RAT, a first signalling message duplicated from a second signalling message. The entity may be an upper entity with respect to a MAC entity. For example, the entity of the first RAT in the first wireless device may perform a duplication of the second signalling message to obtain the first signalling message duplicated from the second signalling message. The contents of the first signalling message (i.e., duplicated signalling message) may be the same as that of the second signalling message.

In step S1603, the first wireless device may transmit the first signalling message on a carrier of the first RAT and the second signalling message on a carrier of a second RAT. The second signalling message may be transmitted with information informing that a duplication is performed by the entity of the first RAT.

According to various embodiments, the first wireless device may perform the duplication of the second signalling message to obtain the first signalling message duplicated from the second signalling message. The duplication may be performed based on that a single carrier is available for the first RAT and at least one carrier on the second RAT is available for the duplication.

According to various embodiments, the first wireless device may transmit, to a second wireless device via sidelink, the first signalling message on a carrier of the first RAT and the second signalling message on a carrier of a second RAT. The first wireless device may receive, from the second wireless device via sidelink, feedback information for at least one of the first signalling message or the second signalling message. The first wireless device may perform a re-transmission of at least one of the first signalling message or the second signalling message on the carrier of the first RAT, to the second wireless device via sidelink.

According to various embodiments, the information may comprise sidelink control information (SCI) informing that the duplication is performed by the entity of the first RAT.

According to various embodiments, the second signalling message may be included in a MAC protocol data unit (PDU). The information may be included in a header of the MAC PDU. For example, the header of the MAC PDU may comprise the SCI informing that the duplication is performed by the entity of the first RAT.

According to various embodiments, the information may correspond to a logical channel identity (LCID) field of the header of the MAC PDU, or a version field of the header of the MAC PDU.

According to various embodiments, the first RAT may comprise a new radio (NR), and the second RAT may comprise a long-term evolution (LTE).

According to various embodiments, the entity may comprise a packet data convergence protocol (PDCP) entity.

According to various embodiments, the first signalling message may be transmitted with information informing that the duplication is performed on the first RAT and the second RAT.

According to various embodiments, the first wireless device may receive, from a second wireless device to which the first signalling message and the second signalling message are transmitted, a first response message for at least one of the first signalling message and the second signalling message on the carrier of the first RAT, and a second response message duplicated from the first response message on the carrier of the second RAT.

According to various embodiments, the first signalling message and the second signalling message may comprise a PC5 request message. The first response message and the second response message may comprise a PC5 response message.

According to various embodiments, the first wireless device may perform a sidelink transmission to the second wireless device on the carrier of the first RAT after receiving the first response message and the second response message.

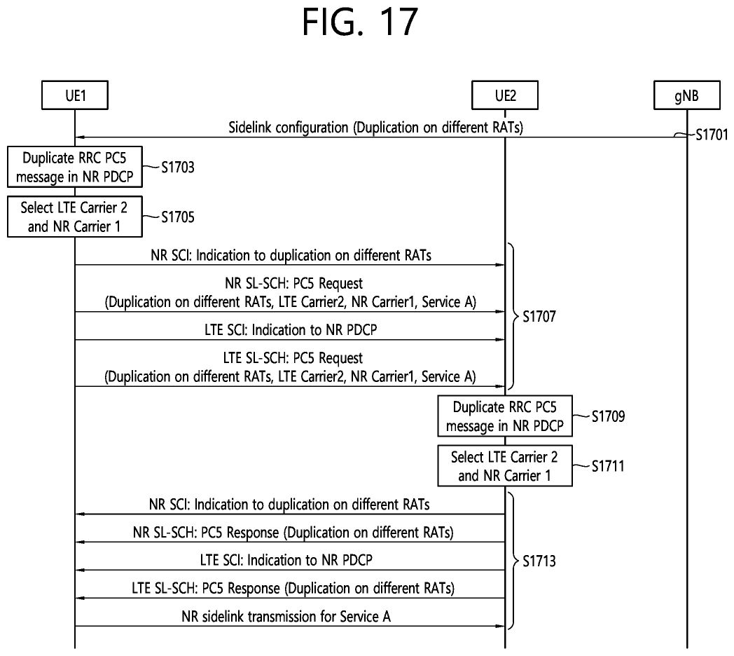

FIG. 17 shows an example of signalling message exchange between UEs according to an embodiment of the present disclosure. The signalling may comprise sidelink PC5 signalling, and the UEs may communicate sidelink communication with each other.

Referring to FIG. 17, in step S1701, the UE1 may receive a sidelink configuration for configuring a duplication on different RATs from a network. The UE1 may determine a transmission of a signalling message for a service via the first RAT. If a duplication is configured for the signalling message, the signalling message may indicate at least one of a duplication on a single RAT or a duplication on different RATs, the carrier(s) where the UE1 transmits the signalling messages with duplication, the RAT(s) where the UE1 transmits the signalling messages with duplication, the carrier(s) where the UE2 can transmit a response message and the UE1 will monitor to receive the response message, or the RAT(s) where the UE2 can transmit a response message and the UE1 will monitor to receive the response message. The service may comprise a unicast service. The transmission of the signalling message may comprise sidelink broadcast transmission.

If a duplication is configured for the signalling message, the UE1 may determine whether or not more than one carrier of the first RAT is available for transmission of the signalling message. The UE1 may determine that more than one carrier of the first RAT is not available for transmission of the signalling message in at least one of the following cases:

1) the UE1 cannot select more than one carrier for the first RAT due to limited UE capability.

2) the service associated with the signalling message is not mapped to more than one carrier of the first RAT

3) the type of the signalling message is not mapped to more than one carrier of the first RAT

4) a logical channel (or a radio bearer) of the signalling message is not mapped to more than one carrier of the first RAT

5) the priority associated with the signalling message (e.g. logical channel priority) is above or equal to a threshold indicated by the network.

6) the priority associated with the signalling message (e.g. logical channel priority) is below or equal to a threshold indicated by the network.

7) the network controlling the UE1 indicates to the UE1 that the first RAT is not available for duplication.

8) a duplication of the signalling message is configured only for the second RAT by pre-configuration or configured by the network.

If more than one carrier of the first RAT is not available for duplication, the UE1 may determine whether or not the second RAT is available for transmission of the signalling message. The UE1 may determine that the second RAT is available for transmission of the signalling message in at least one of the following cases:

1) the service associated with the signalling message is mapped to the second RAT

2) the type of the signalling message is mapped to the second RAT

3) a logical channel (or a radio bearer) of the signalling message is mapped to the second RAT

4) the priority associated with the signalling message (e.g. logical channel priority) is above or equal to a threshold indicated by the network. Alternatively, the priority associated with the signalling message (e.g. logical channel priority) is below or equal to a threshold indicated by the network.

5) the network controlling the UE1 indicates to the UE1 that the second RAT is available for transmission of the signalling message

6) a duplication of the signalling message is configured by pre-configuration or configured by the network.

The first RAT may comprise NR while the second RAT may comprise LTE.

If the first RAT is available for duplication, the UE1 may duplicate the signalling message for the first RAT. Then, the UE1 may perform a transmission of the signalling message on a carrier of the first RAT and transmission of the duplicated signalling message on another carrier of the first RAT. The UE1 may perform duplication in the PDCP entity of the first RAT (i.e., NR PDCP).

After a transmission of the signalling message with duplication, if the UE1 indicates a duplication in the signalling message, the UE1 may monitor the carriers of the first RAT where the signalling message was transmitted in order to receive a response message from the UE2.

After a transmission of the signalling message with duplication, if the UE1 indicates no duplication in the signalling message, the UE1 may monitor one of the carriers of the first RAT where the signalling message was transmitted in order to receive a response message from the UE2. The UE1 may indicate the monitored carrier in the signalling message.

In step S1703, if the first RAT is not available for duplication but the second RAT is available for duplication, the UE1 may duplicate the signalling message for the first RAT and the second RAT.

In step S1705, the UE1 may select a carrier of the first RAT (e.g., NR carrier 1) and a carrier of the second RAT (e.g., LTE carrier 2).

In step S1707, the UE1 may perform a transmission of the signalling message on a carrier of the first RAT and a transmission of the duplicated signalling message on a carrier of the second RAT.

If configured, when NACK feedback is received from the UE2, the UE1 may re-transmit the signalling message on the first RAT.

The UE1 may re-transmit the signalling message on the second RAT without any feedback, or the UE1 may not perform retransmission on the second RAT.

After a transmission of the signalling message with duplication, if the UE1 indicates duplication in the signalling message, the UE1 may monitor the carrier of the first RAT and the carrier of the second RAT in order to receive a response message from the UE2. If neither the first RAT nor the second RAT are available for duplication, the UE1 may not perform duplication so that the UE1 can perform a transmission of the signalling message only on a carrier of the first RAT.

Transmission of the signalling message may comprise a transmission of SCI and a transmission of a MAC PDU carrying the signalling message. If NR PDCP is used for delivery of the MAC PDU, the SCI and/or the header of the MAC PDU may indicate that NR PDCP is used for delivery of the signalling message.

The UE2 may receive the SCI and/or the MAC PDU carrying the signalling message. If the SCI and/or the header of the MAC PDU indicates that NR PDCP is used for the signalling message, the UE2 may establish an NR PDCP entity and deliver the data unit included in the received MAC PDU to the NR PDCP entity. Then, the NR PDCP entity of the UE2 may deliver the data unit to the PC5-RRC and/or the PC5-S protocol entity which interprets the signalling message.

A field included in the header of the MAC PDU, such as logical channel ID (LCID) and/or a version field (i.e., V field) in the header of the MAC PDU may be used to indicate NR PDCP.

In step S1709, upon receiving the signalling message from the UE1, if the signalling message indicates the duplication on different RATs, the UE2 may duplicate a response message.

In step S1711, the UE2 may select a carrier of the first RAT (e.g., NR carrier 1) and a carrier of the second RAT (e.g., LTE carrier 2), to transmit the response message.

In step S1713, the UE2 may transmit the response message on different RATs. However, if the signalling message indicates the duplication on a single RAT, the UE2 may duplicate the response message and transmit the response message on the single RAT.

Upon receiving the response message from the UE2, the UE1 may begin to perform sidelink transmission on the first RAT for the service. The sidelink transmission may comprise sidelink unicast transmission.

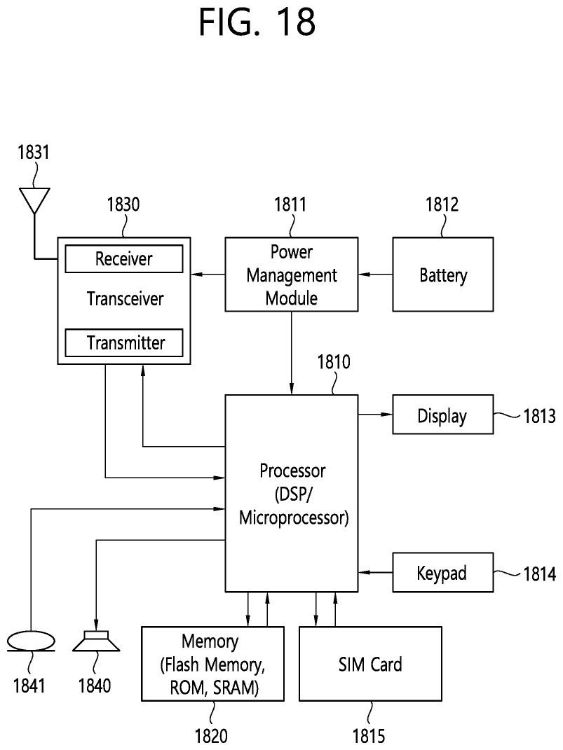

FIG. 18 shows a UE to implement an embodiment of the present disclosure. The present disclosure described above for UE side may be applied to this embodiment.

A UE includes a processor 1810, a power management module 1811, a battery 1812, a display 1813, a keypad 1814, a subscriber identification module (SIM) card 1815, a memory 1820, a transceiver 1830, one or more antennas 1831, a speaker 1840, and a microphone 1841. The processor 1810 may be configured to implement proposed functions, procedures and/or methods described in this description. Layers of the radio interface protocol may be implemented in the processor 1810. The processor 1810 may include application-specific integrated circuit (ASIC), other chipset, logic circuit and/or data processing device. The processor 1810 may be an application processor (AP). The processor 1810 may include at least one of a digital signal processor (DSP), a central processing unit (CPU), a graphics processing unit (GPU), a modem (modulator and demodulator). An example of the processor 1810 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The processor 1810 may be configured to, or configured to control the transceiver 1830 to implement steps performed by the UE and/or the wireless device throughout the disclosure.

The power management module 1811 manages power for the processor 1810 and/or the transceiver 1830. The battery 1812 supplies power to the power management module 1811. The display 1813 outputs results processed by the processor 1810. The keypad 1814 receives inputs to be used by the processor 1810. The keypad 1814 may be shown on the display 1813. The SIM card 1815 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The memory 1820 is operatively coupled with the processor 1810 and stores a variety of information to operate the processor 1810. The memory 1820 may include read-only memory (ROM), random access memory (RAM), flash memory, memory card, storage medium and/or other storage device. When the embodiments are implemented in software, the techniques described herein can be implemented with modules (e.g., procedures, functions, and so on) that perform the functions described herein. The modules can be stored in the memory 1820 and executed by the processor 1810. The memory 1820 can be implemented within the processor 1810 or external to the processor 1810 in which case those can be communicatively coupled to the processor 1810 via various means as is known in the art.

The transceiver 1830 is operatively coupled with the processor 1810, and transmits and/or receives a radio signal. The transceiver 1830 includes a transmitter and a receiver. The transceiver 1830 may include baseband circuitry to process radio frequency signals. The transceiver 1830 controls the one or more antennas 1831 to transmit and/or receive a radio signal.

The speaker 1840 outputs sound-related results processed by the processor 1810. The microphone 1841 receives sound-related inputs to be used by the processor 1810.

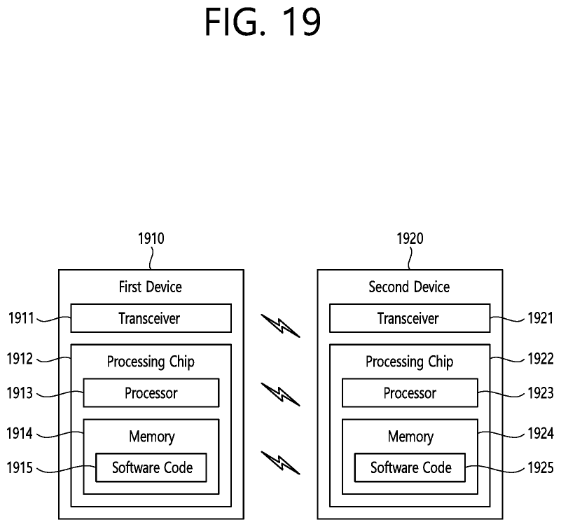

FIG. 19 shows another example of a wireless communication system to which the technical features of the present disclosure can be applied.

Referring to FIG. 19, the wireless communication system may include a first device 1910 (i.e., first device 210) and a second device 1920 (i.e., second device 220).

The first device 1910 may include at least one transceiver, such as a transceiver 1911, and at least one processing chip, such as a processing chip 1912. The processing chip 1912 may include at least one processor, such a processor 1913, and at least one memory, such as a memory 1914. The memory may be operably connectable to the processor 1913. The memory 1914 may store various types of information and/or instructions. The memory 1914 may store a software code 1915 which implements instructions that, when executed by the processor 1913, perform operations of the first device 910 described throughout the disclosure. For example, the software code 1915 may implement instructions that, when executed by the processor 1913, perform the functions, procedures, and/or methods of the first device 1910 described throughout the disclosure. For example, the software code 1915 may control the processor 1913 to perform one or more protocols. For example, the software code 1915 may control the processor 1913 to perform one or more layers of the radio interface protocol.

The second device 1920 may include at least one transceiver, such as a transceiver 1921, and at least one processing chip, such as a processing chip 1922. The processing chip 1922 may include at least one processor, such a processor 1923, and at least one memory, such as a memory 1924. The memory may be operably connectable to the processor 1923. The memory 1924 may store various types of information and/or instructions. The memory 1924 may store a software code 1925 which implements instructions that, when executed by the processor 1923, perform operations of the second device 1920 described throughout the disclosure. For example, the software code 1925 may implement instructions that, when executed by the processor 1923, perform the functions, procedures, and/or methods of the second device 1920 described throughout the disclosure. For example, the software code 1925 may control the processor 1923 to perform one or more protocols. For example, the software code 1925 may control the processor 1923 to perform one or more layers of the radio interface protocol.

The present disclosure may be applied to various future technologies, such as AI, robots, autonomous-driving/self-driving vehicles, and/or extended reality (XR).

<AI>

AI refers to artificial intelligence and/or the field of studying methodology for making it. Machine learning is a field of studying methodologies that define and solve various problems dealt with in AI. Machine learning may be defined as an algorithm that enhances the performance of a task through a steady experience with any task.

An artificial neural network (ANN) is a model used in machine learning. It can mean a whole model of problem-solving ability, consisting of artificial neurons (nodes) that form a network of synapses. An ANN can be defined by a connection pattern between neurons in different layers, a learning process for updating model parameters, and/or an activation function for generating an output value. An ANN may include an input layer, an output layer, and optionally one or more hidden layers. Each layer may contain one or more neurons, and an ANN may include a synapse that links neurons to neurons. In an ANN, each neuron can output a summation of the activation function for input signals, weights, and deflections input through the synapse. Model parameters are parameters determined through learning, including deflection of neurons and/or weights of synaptic connections. The hyper-parameter means a parameter to be set in the machine learning algorithm before learning, and includes a learning rate, a repetition number, a mini batch size, an initialization function, etc. The objective of the ANN learning can be seen as determining the model parameters that minimize the loss function. The loss function can be used as an index to determine optimal model parameters in learning process of ANN.

Machine learning can be divided into supervised learning, unsupervised learning, and reinforcement learning, depending on the learning method. Supervised learning is a method of learning ANN with labels given to learning data. Labels are the answers (or result values) that ANN must infer when learning data is input to ANN. Unsupervised learning can mean a method of learning ANN without labels given to learning data. Reinforcement learning can mean a learning method in which an agent defined in an environment learns to select a behavior and/or sequence of actions that maximizes cumulative compensation in each state.

Machine learning, which is implemented as a deep neural network (DNN) that includes multiple hidden layers among ANN, is also called deep learning. Deep learning is part of machine learning. In the following, machine learning is used to mean deep learning.

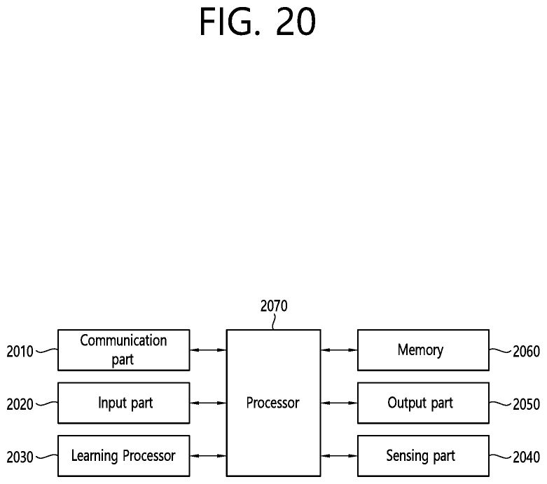

FIG. 20 shows an example of an AI device to which the technical features of the present disclosure can be applied.

The AI device 2000 may be implemented as a stationary device or a mobile device, such as a TV, a projector, a mobile phone, a smartphone, a desktop computer, a notebook, a digital broadcasting terminal, a PDA, a PMP, a navigation device, a tablet PC, a wearable device, a set-top box (STB), a digital multimedia broadcasting (DMB) receiver, a radio, a washing machine, a refrigerator, a digital signage, a robot, a vehicle, etc.

Referring to FIG. 20, the AI device 2000 may include a communication part 2010, an input part 2020, a learning processor 2030, a sensing part 2040, an output part 2050, a memory 2060, and a processor 2070.

The communication part 2010 can transmit and/or receive data to and/or from external devices such as the AI devices and the AI server using wire and/or wireless communication technology. For example, the communication part 2010 can transmit and/or receive sensor information, a user input, a learning model, and a control signal with external devices. The communication technology used by the communication part 2010 may include a global system for mobile communication (GSM), a code division multiple access (CDMA), an LTE/LTE-A, a 5G, a WLAN, a Wi-Fi, Bluetooth™, radio frequency identification (RFID), infrared data association (IrDA), ZigBee, and/or near field communication (NFC).

The input part 2020 can acquire various kinds of data. The input part 2020 may include a camera for inputting a video signal, a microphone for receiving an audio signal, and a user input part for receiving information from a user. A camera and/or a microphone may be treated as a sensor, and a signal obtained from a camera and/or a microphone may be referred to as sensing data and/or sensor information. The input part 2020 can acquire input data to be used when acquiring an output using learning data and a learning model for model learning. The input part 2020 may obtain raw input data, in which case the processor 2070 or the learning processor 2030 may extract input features by preprocessing the input data.

The learning processor 2030 may learn a model composed of an ANN using learning data. The learned ANN can be referred to as a learning model. The learning model can be used to infer result values for new input data rather than learning data, and the inferred values can be used as a basis for determining which actions to perform. The learning processor 2030 may perform AI processing together with the learning processor of the AI server. The learning processor 2030 may include a memory integrated and/or implemented in the AI device 2000. Alternatively, the learning processor 2030 may be implemented using the memory 2060, an external memory directly coupled to the AI device 2000, and/or a memory maintained in an external device.

The sensing part 2040 may acquire at least one of internal information of the AI device 2000, environment information of the AI device 2000, and/or the user information using various sensors. The sensors included in the sensing part 2040 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a light detection and ranging (LIDAR), and/or a radar.

The output part 2050 may generate an output related to visual, auditory, tactile, etc. The output part 2050 may include a display unit for outputting visual information, a speaker for outputting auditory information, and/or a haptic module for outputting tactile information.

The memory 2060 may store data that supports various functions of the AI device 2000. For example, the memory 2060 may store input data acquired by the input part 2020, learning data, a learning model, a learning history, etc.

The processor 2070 may determine at least one executable operation of the AI device 2000 based on information determined and/or generated using a data analysis algorithm and/or a machine learning algorithm. The processor 2070 may then control the components of the AI device 2000 to perform the determined operation. The processor 2070 may request, retrieve, receive, and/or utilize data in the learning processor 2030 and/or the memory 2060, and may control the components of the AI device 2000 to execute the predicted operation and/or the operation determined to be desirable among the at least one executable operation. The processor 2070 may generate a control signal for controlling the external device, and may transmit the generated control signal to the external device, when the external device needs to be linked to perform the determined operation. The processor 2070 may obtain the intention information for the user input and determine the user's requirements based on the obtained intention information. The processor 2070 may use at least one of a speech-to-text (STT) engine for converting speech input into a text string and/or a natural language processing (NLP) engine for acquiring intention information of a natural language, to obtain the intention information corresponding to the user input. At least one of the STT engine and/or the NLP engine may be configured as an ANN, at least a part of which is learned according to a machine learning algorithm. At least one of the STT engine and/or the NLP engine may be learned by the learning processor 2030 and/or learned by the learning processor of the AI server, and/or learned by their distributed processing. The processor 2070 may collect history information including the operation contents of the AI device 2000 and/or the user's feedback on the operation, etc. The processor 2070 may store the collected history information in the memory 2060 and/or the learning processor 2030, and/or transmit to an external device such as the AI server. The collected history information can be used to update the learning model. The processor 2070 may control at least some of the components of AI device 2000 to drive an application program stored in memory 2060. Furthermore, the processor 2070 may operate two or more of the components included in the AI device 2000 in combination with each other for driving the application program.

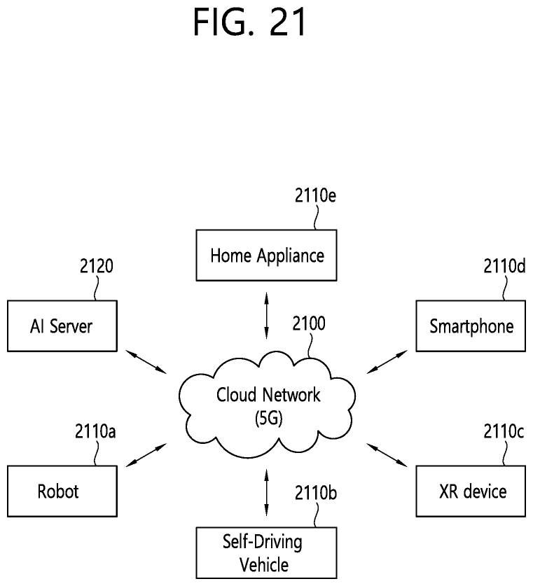

FIG. 21 shows an example of an AI system to which the technical features of the present disclosure can be applied.

Referring to FIG. 21, in the AI system, at least one of an AI server 2120, a robot 2110a, an autonomous vehicle 2110b, an XR device 2110c, a smartphone 2110d and/or a home appliance 2110e is connected to a cloud network 2100. The robot 2110a, the autonomous vehicle 2110b, the XR device 2110c, the smartphone 2110d, and/or the home appliance 2110e to which the AI technology is applied may be referred to as AI devices 2110a to 2110e.

The cloud network 2100 may refer to a network that forms part of a cloud computing infrastructure and/or resides in a cloud computing infrastructure. The cloud network 2100 may be configured using a 3G network, a 4G or LTE network, and/or a 5G network. That is, each of the devices 2110a to 2110e and 2120 consisting the AI system may be connected to each other through the cloud network 2100. In particular, each of the devices 2110a to 2110e and 2120 may communicate with each other through a base station, but may directly communicate with each other without using a base station.

The AI server 2120 may include a server for performing AI processing and a server for performing operations on big data. The AI server 2120 is connected to at least one or more of AI devices constituting the AI system, i.e. the robot 2110a, the autonomous vehicle 2110b, the XR device 2110c, the smartphone 2110d and/or the home appliance 2110e through the cloud network 2100, and may assist at least some AI processing of the connected AI devices 2110a to 2110e. The AI server 2120 can learn the ANN according to the machine learning algorithm on behalf of the AI devices 2110a to 2110e, and can directly store the learning models and/or transmit them to the AI devices 2110a to 2110e. The AI server 2120 may receive the input data from the AI devices 2110a to 2110e, infer the result value with respect to the received input data using the learning model, generate a response and/or a control command based on the inferred result value, and transmit the generated data to the AI devices 2110a to 2110e. Alternatively, the AI devices 2110a to 2110e may directly infer a result value for the input data using a learning model, and generate a response and/or a control command based on the inferred result value.

Various embodiments of the AI devices 2110a to 2110e to which the technical features of the present disclosure can be applied will be described. The AI devices 2110a to 2110e shown in FIG. 21 can be seen as specific embodiments of the AI device 2000 shown in FIG. 20.

The present disclosure can have various advantageous effects.

For example, a wireless device may duplicate and transmit a signalling message on different RATs and transmit information indicating that the duplication is performed by an entity of a specific RAT (e.g., NR), so that the wireless device can support a reliable transmission of the signalling message (e.g., control plane message).

For example, a UE can support a reliable transmission of a control plane message in sidelink by using multiple RATs, in particular when V2X sidelink communication is configured in both LTE and NR for a unicast service.

Various embodiments of the present disclosure are beneficial in that the system can provide reliable delivery of signalling to UEs in sidelink transmissions.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope of the present disclosure.

Claims in the present description can be combined in a various way. For instance, technical features in method claims of the present description can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

What is claimed is:

1. A method performed by a first wireless device in a wireless communication system, the method comprising:
generating, by an entity of a first radio access technology (RAT), a first signalling message duplicated from a second signalling message; and
transmitting the first signalling message on a carrier of the first RAT and the second signalling message on a carrier of a second RAT,
wherein the second signalling message is transmitted with information informing that a duplication is performed by the entity of the first RAT, and
wherein the entity is an upper entity with respect to a media access control (MAC) entity.

2. The method of claim 1, wherein the generating of the first signalling message comprises performing the duplication of the second signalling message to obtain the first signalling message duplicated from the second signalling message, and
wherein the duplication is performed based on that a single carrier is available for the first RAT and at least one carrier on the second RAT is available for the duplication.

3. The method of claim 1, wherein the transmitting of the first signalling message and the signalling message comprises transmitting, to a second wireless device via sidelink, the first signalling message on a carrier of the first RAT and the second signalling message on a carrier of a second RAT, further comprising:
receiving, from the second wireless device via sidelink, feedback information for at least one of the first signalling message or the second signalling message; and
performing a re-transmission of at least one of the first signalling message or the second signalling message on the carrier of the first RAT, to the second wireless device via sidelink.

4. The method of claim 1, wherein the information comprises sidelink control information (SCI) informing that the duplication is performed by the entity of the first RAT.

5. The method of claim 1, wherein the second signalling message is included in a MAC protocol data unit (PDU), and
wherein the information is included in a header of the MAC PDU.

6. The method of claim 5, wherein the information corresponds to a logical channel identity (LCID) field of the header of the MAC PDU, or a version field of the header of the MAC PDU.

7. The method of claim 1, wherein the first RAT comprises a new radio (NR), and the second RAT comprises a long-term evolution (LTE).

8. The method of claim 1, wherein the entity comprises a packet data convergence protocol (PDCP) entity.

9. The method of claim 1, wherein the first signalling message is transmitted with information informing that the duplication is performed on the first RAT and the second RAT.

10. The method of claim 1, further comprising:
receiving, from a second wireless device to which the first signalling message and the second signalling message are transmitted, a first response message for at least one of the first signalling message and the second signalling message on the carrier of the first RAT, and a second response message duplicated from the first response message on the carrier of the second RAT.

11. The method of claim 10, wherein the first signalling message and the second signalling message comprise a PC5 request message, and
wherein the first response message and the second response message comprise a PC5 response message.

12. The method of claim 10, further comprising:
after receiving the first response message and the second response message, performing a sidelink transmission to the second wireless device on the carrier of the first RAT.

13. The method of claim 1, wherein the first wireless device is in communication with at least one of a user equipment, a network, and/or autonomous vehicles other than the wireless device.

14. A wireless device in a wireless communication system comprising:
a transceiver;
a memory; and
at least one processor operatively coupled to the transceiver and the memory, and configured to:
generate, by an entity of a first radio access technology (RAT), a first signalling message duplicated from a second signalling message, and
control the transceiver to transmit the first signalling message on a carrier of the first RAT and the second signalling message on a carrier of a second RAT,
wherein the second signalling message is transmitted with information informing that a duplication is performed by the entity of the first RAT, and
wherein the entity is an upper entity with respect to a media access control (MAC) entity.

15. A processor for a wireless device in a wireless communication system, wherein the processor is configured to control the wireless device to perform operations comprising:
generating, by an entity of a first radio access technology (RAT), a first signalling message duplicated from a second signalling message; and
transmitting the first signalling message on a carrier of the first RAT and the second signalling message on a carrier of a second RAT,
wherein the second signalling message is transmitted with information informing that a duplication is performed by the entity of the first RAT, and
wherein the entity is an upper entity with respect to a media access control (MAC) entity.
